(19) United States
(12) Patent Application Publication
(10) Pub. No.: US 2026/0288806 A1
(43) Pub. Date: Sep. 24, 2026

(54) SYSTEM

(71) Applicant: SoftBank Group Corp., Tokyo (JP)

(72) Inventor: Shuhei YOSHIKAWA, Tokyo (JP)

(73) Assignee: SoftBank Group Corp., Tokyo (JP)

(21) Appl. No.: 19/565,638

(22) Filed: Mar. 13, 2026

(30) Foreign Application Priority Data
Mar. 19, 2025 (JP) 2025-045096

(51) Int. Cl. G06F 16/3329; G06F 16/334; G06F 16/34; G06T 13/40; G10L 13/08; G10L 15/26

(52) U.S. Cl. CPC G06F 16/33295; G06F 16/3347; G06F 16/345; G06T 13/40; G10L 13/08; G10L 15/26

(57) ABSTRACT

A system includes a processor that is configured to convert publicly available information including audio data into text data by using a speech recognition technique, input the text data into a generative AI model by using a prompt that instructs the generative AI model to perform at least one of summarizing the text data and extracting important information from the text data, process question-and-answer content included in the publicly available information by using an interactive program, and use a prompt with the generative AI model to instruct automation of the question-and-answer content so as to realize a fully automated training.

### CROSS-REFERENCE TO RELATED APPLICATION

This application is based on and claims priority under 35 USC 119 from Japanese Patent Application No. 2025-045096 filed on March 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional training systems that utilize recorded lectures or publicly available educational content generally require significant manual intervention by instructors or administrators in order to (i) convert audio information into usable textual materials, (ii) summarize and extract key points from the content, and (iii) respond to questions from trainees. In particular, when large volumes of publicly available information, such as online lectures, seminars, and training videos, are reused, it is burdensome to manually perform transcription and summarization work, and it is difficult to efficiently construct structured training materials and agendas. Furthermore, in conventional systems, question-and-answer sessions during or after training commonly require a human instructor or operator to be present in real time, which increases labor costs and limits scalability and availability of the training.

Although speech recognition techniques and generative AI models have individually been proposed, existing systems do not satisfactorily integrate these technologies into a single, coherent training platform that automatically converts publicly available audio information to text, automatically performs summarization and key information extraction, and automatically handles question-and-answer interactions. As a result, there remains a need for a system that can provide fully automated training by combining speech recognition, generative AI models, and interactive programs such as chatbots, including the ability to automatically process question-and-answer content without human intervention, while also enabling the generation of virtual instructors that mimic human-like expressions and movements.

Accordingly, an object of the present invention is to provide a system that reduces or eliminates the manual workload associated with preparing and delivering training based on publicly available information, and that realizes fully automated training from content ingestion and material generation through to automated question-and-answer handling, optionally including a virtual instructor representation.

### SUMMARY

In order to achieve the above-described object, a system according to one aspect of the present invention comprises a processor configured to perform a series of automated processing steps on publicly available information that includes audio data. Specifically, the processor is configured to convert the audio data included in the publicly available information into text data by using a speech recognition technique. By using speech recognition, the system can automatically generate accurate and searchable textual representations of lectures, seminars, or training videos without requiring manual transcription by an instructor or administrator.

The processor is further configured to input the text data into a generative AI model by using a prompt that instructs the generative AI model to perform at least one of summarizing the text data and extracting important information from the text data. By appropriately designing the prompt, the processor causes the generative AI model to automatically produce summarized content, key points, and other structured outputs, such as agenda items or training material elements, which can be used directly in the construction of training resources.

In addition, the processor is configured to process question-and-answer content included in the publicly available information by using an interactive program, such as a chatbot engine, and to use a prompt with the generative AI model to instruct automation of the question-and-answer content so as to realize a fully automated training. In this manner, the processor can automatically generate responses to questions from trainees based on the converted text data, the summarized results, and other contextual information, thereby eliminating the need for a live instructor to handle each question.

According to another aspect, the processor may be configured to use the speech recognition technique specifically when converting the audio data into the text data, thereby improving accuracy and efficiency of transcription for various types of publicly available audio content. Furthermore, the processor may be configured to mimic facial expressions and movements of a virtual person based on data generated by the generative AI model, enabling the system to generate a virtual instructor or digital human that visually presents the training content. By integrating these functions, the system according to the present invention realizes a comprehensive, fully automated training environment that covers content ingestion, material generation, virtual instructor presentation, and automated question-and-answer processing.

The term “system” refers to an integrated combination of hardware and software components, including at least one processor and associated memory and interfaces, that are configured to execute programmed instructions to perform the functions described in the present specification and claims.

The term “processor” refers to one or more hardware processing units, such as a central processing unit (CPU), graphics processing unit (GPU), digital signal processor (DSP), or other computing circuitry, which execute instructions stored in a memory to perform arithmetic, logical, control, and input/output operations necessary to implement the functions of the invention.

The term “publicly available information” refers to information, including audio, video, and textual content, that is accessible to the general public through networks or media such as the Internet, public databases, or publicly distributed recordings, without the need for individualized authentication, closed-group membership, or special contractual access.

The term “audio data” refers to data representing sound, including but not limited to speech contained in lecture recordings, training videos, seminars, or other media, in analog or digital form, which can be processed by a speech recognition technique to produce corresponding text data.

The term “text data” refers to data expressed in a textual format, including characters, words, sentences, and structured documents, derived from audio data via speech recognition or generated by a generative AI model, and suitable for further processing such as summarization, key information extraction, or question-answering.

The term “speech recognition technique” refers to a technique or algorithm, implemented in software and/or hardware, that analyzes audio data and automatically converts spoken language into corresponding text data, and may include acoustic modeling, language modeling, and decoding processes.

The term “generative AI model” refers to a machine learning model, such as a large language model, that is trained on large-scale data to generate outputs including text, prompts, or other data in response to input data, and which is capable of performing tasks such as summarization, key information extraction, and answer generation based on provided context.

The term “prompt” refers to a structured input instruction, including text and optionally additional parameters or context, that is provided to a generative AI model to specify or guide the type, format, and content of the output to be generated by the generative AI model.

The term “summarizing” refers to processing text data to produce a shorter representation that preserves essential meaning and main ideas of the original content, while omitting less important details, so that the resulting text is more concise and easier to understand.

The term “extracting important information” refers to identifying and outputting key points, topics, entities, or other salient elements from text data, such as main ideas, bullet points, or agenda items, which are particularly useful for constructing training materials or outlines.

The term “question-and-answer content” refers to information that includes questions, answers, or both, such as inquiries made by trainees and corresponding responses, or Q&A segments embedded in lectures or training materials, which are to be processed and automated by the system.

The term “interactive program” refers to a software component or application that exchanges messages with a user in a conversational or interactive manner, such as a chatbot or dialogue system, and which cooperates with the generative AI model to process questions and generate responses.

The term “fully automated training” refers to a training process in which preparation and delivery of training content, including transcription, summarization, key information extraction, and handling of question-and-answer interactions, are performed automatically by the system without requiring real-time human intervention by an instructor.

The term “virtual person” refers to a computer-generated character or avatar, including a digital human, that visually represents a person and is capable of displaying facial expressions and movements to simulate the behavior of a human instructor or presenter.

The term “facial expressions and movements” refers to visual changes and motions of a virtual person’s face and body, including lip synchronization, eye movements, gestures, and postures, which are controlled to mimic human-like behavior during presentation of training content.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

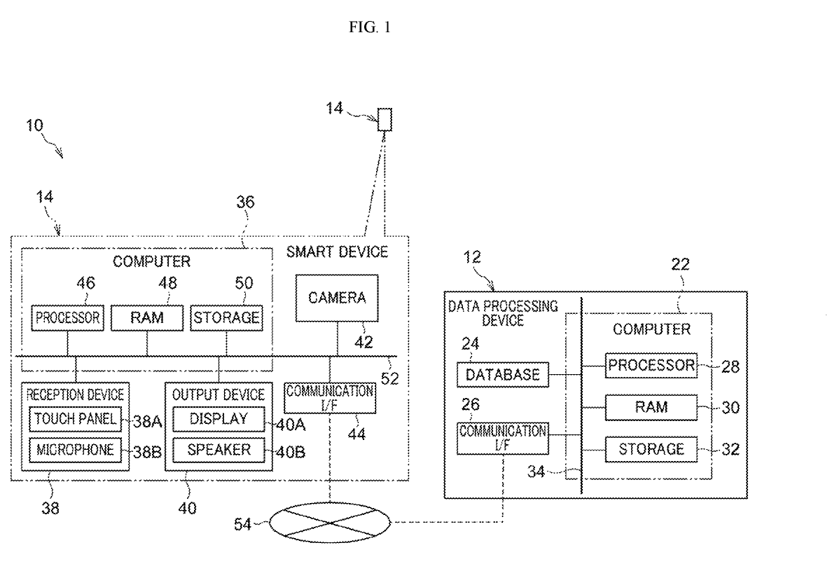

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

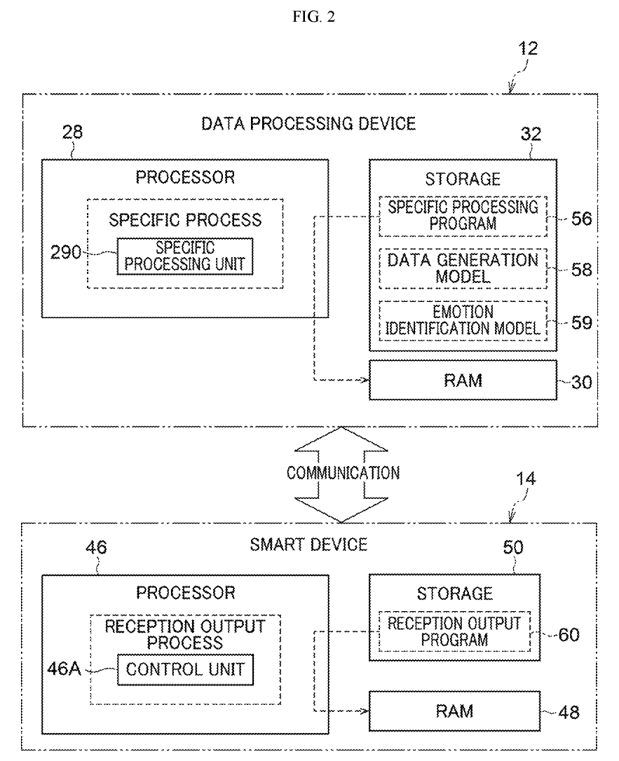

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented training and lecture systems primarily handle digital content as static files or simple streams, and therefore require substantial manual intervention by human operators to convert public audio or video into usable text, to construct appropriate prompt sentences for a generative AI model, and to orchestrate interactive question-and-answer sessions. In many cases, separate software tools are used in isolation for media extraction, speech recognition, text post-processing, prompt crafting, and dialogue management, and these tools are loosely coupled through manual copy-and-paste operations performed by a user at a terminal. As a result, end-to-end processing from raw public media to automated training content remains fragmented, error-prone, and resource-intensive.

Moreover, existing systems typically do not provide an integrated computational mechanism that structures recognized text as machine-usable distribution data, derives prompt sentences in a systematic and repeatable way from that distribution data, and feeds those prompt sentences into a generative AI model to automatically produce summaries, key information, training materials, and interactive response data. In such systems, the burden of transforming recognized text into effective prompt sentences suitable for a generative AI model rests on individual users, leading to inconsistent quality of generated outputs and inefficient utilization of computing resources.

Further, conventional architectures for virtual instructors and interactive training tend to rely on pre-authored scripts and manually curated question-answer pairs. They generally do not construct a search-ready internal representation of the transcript data, such as numerical feature representations suitable for similarity-based retrieval, nor do they automatically generate prompts to a generative AI model based on retrieval results. Consequently, these systems have limited scalability, adaptability to new content, and responsiveness to user questions, and do not fully exploit advances in generative AI models at the system architecture and processing-pipeline level.

There is therefore a need for an improved computer system and associated processing techniques that: (i) automatically transform public audio or video into cleaned and formatted distribution data; (ii) automatically derive and supply structured prompt sentences to a generative AI model to obtain summary data, important information data, educational material data, and interactive response data; (iii) construct and utilize numerical feature representations of the distribution data to perform efficient similarity-based retrieval in response to user questions; and (iv) generate and synchronize virtual person motion and speech from generated data to realize fully automated, interactive training with reduced manual intervention and improved computational efficiency. The technical problem addressed by the present invention is to improve the functioning of the computer system itself by providing an integrated, automated processing pipeline that coordinates media processing, speech recognition, feature transformation, retrieval, generative AI prompting, and virtual instructor rendering in a unified architecture.

The specific processing by the specific processing unit 290 of the data processing device 12 in Example 1 is realized by the following means.

The present invention provides a server comprising a processor, a storage device, and a communication device, the processor being configured to receive, via the communication device, information including audio or video obtained from a public medium, to store the information in the storage device, to execute media processing and speech recognition programs to separate an audio component from the stored information and convert the audio component into character information, to perform text-formatting processing on the character information to generate distribution data, to generate instruction information for creation of a prompt sentence that instructs at least one of summarization, important information extraction, educational material creation, and interactive response generation based on the distribution data, to input the distribution data and the prompt sentence to a generative information processing model in accordance with the instruction information so as to obtain at least one of summary data, important information data, educational material data, and interactive response data, to convert the character information and other data stored in the storage device into numerical representations using a feature transformation program, to construct a search data set based on the numerical representations, to convert a question sentence from a user into a numerical representation, to calculate similarity between the numerical representation of the question sentence and the search data set, to extract related information based on the similarity and generate a further prompt sentence including the question sentence and the related information, to input the further prompt sentence to the generative information processing model so as to cause the generative information processing model to generate a response sentence, to generate motion information and speech information of a virtual person based on at least one of the summary data, the important information data, and the educational material data, to input the speech information to a speech synthesis program to generate synthetic speech, and to synchronize the synthetic speech with the motion information to generate display images and audio output of the virtual person, and to generate processing state information according to at least one of a creation state of the distribution data and a creation state of the prompt sentence, and transmit the processing state information and at least one of the distribution data and output data from the generative information processing model to a terminal device via the communication device for display. This enables improved computer functionality by providing an integrated and automated processing pipeline that reduces manual operations, enhances consistency and efficiency in transforming public media into structured training content, leverages numerical feature representations for scalable similarity-based retrieval and dynamic prompt generation, and automatically produces synchronized virtual instructor presentations and interactive question-and-answer sessions using the generative AI model.

The term “system” refers to a combination of hardware and software components that cooperate to perform the processing operations described in the claims, including at least a processor, a storage device, and a communication device.

The term “processor” refers to one or more hardware processing units, such as a central processing unit or other computing circuitry, configured to execute instructions of one or more programs to perform the functions described in the claims.

The term “storage device” refers to a non-transitory computer-readable medium, such as a magnetic storage, optical storage, or semiconductor memory, configured to store data and programs used by the processor.

The term “communication device” refers to a hardware interface, such as a network interface controller, wireless communication module, or similar communication circuitry, configured to send and receive data between the system and external devices or networks.

The term “public medium” refers to any information source that is generally accessible, including but not limited to publicly available audio content, video content, or multimedia content distributed via networks, broadcasting, or recording media.

The term “information including audio or video” refers to digital data that contains at least an audio component, a video component, or both, such as an audio file, a video file, or a multimedia stream.

The term “media processing program” refers to a software module executed by the processor that analyzes, decodes, or transforms audio or video data, including operations such as demultiplexing, format conversion, or extraction of an audio component from multimedia data.

The term “audio component” refers to a data stream or data segment representing sound information that has been separated or extracted from information including audio or video.

The term “speech recognition program” refers to a software module executed by the processor, or by an external processing device accessed by the processor, that analyzes audio data and converts spoken language contained in the audio data into character information.

The term “external processing device” refers to a computing resource separate from the system, such as a remote server or cloud service, that provides processing functions including speech recognition and is accessible via the communication device.

The term “character information” refers to textual data obtained by converting audio content into a sequence of characters, symbols, or encoded text representations.

The term “text-formatting processing” refers to operations performed on character information to adjust its structure or representation, including at least insertion of line breaks, normalization of characters, removal of noise, and arrangement into a user-readable format.

The term “distribution data” refers to character information that has been processed and formatted into a structure suitable for delivery to and use by a user, such as a transcript file, document, or other formatted text output.

The term “instruction information” refers to data that defines how a prompt sentence should be constructed or how the generative information processing model should be invoked, including indications of desired tasks such as summarization, important information extraction, educational material creation, or interactive response generation.

The term “prompt sentence” refers to a sequence of natural language text, optionally including embedded content data, that instructs a generative information processing model to perform a specific processing task and to generate corresponding output data.

The term “generative information processing model” refers to a computational model, such as a generative AI model based on machine learning or statistical techniques, that receives input data and a prompt sentence and generates new data, including natural language text, based on the input.

The term “summary data” refers to data generated by the generative information processing model that represents a condensed form of original content contained in the distribution data, with emphasis on key points or essential information.

The term “important information data” refers to data generated by the generative information processing model that identifies or highlights significant elements, such as key concepts, facts, or insights, contained in the distribution data.

The term “educational material data” refers to data generated by the generative information processing model that structures or reformats content into instructional materials, such as outlines, handouts, or training modules.

The term “interactive response data” refers to data generated by the generative information processing model that is intended for use in interactive dialogue or question-and-answer sessions with a user.

The term “feature transformation program” refers to a software module executed by the processor that converts text data or other data into numerical representations, such as feature vectors or embeddings, suitable for similarity calculation or machine processing.

The term “numerical representation” refers to a mathematical representation of data, such as a vector, matrix, or set of numerical values, that encodes characteristics of the original data for computational analysis.

The term “search data set” refers to a collection of numerical representations and associated content identifiers stored in the storage device, which is used by the processor to perform similarity-based retrieval of related information.

The term “question sentence” refers to a text input provided by a user that expresses an inquiry or request for information and is used as a basis for retrieval and response generation.

The term “similarity” refers to a quantitative measure of relatedness between numerical representations, such as a distance or similarity score, used to determine how closely two pieces of data are related.

The term “related information” refers to content selected from the distribution data or derived data based on similarity between a numerical representation of a question sentence and numerical representations stored in the search data set.

The term “response sentence” refers to text output generated by the generative information processing model in response to a prompt sentence including a question sentence and related information.

The term “motion information” refers to data describing movements, poses, or animations of a virtual person, including but not limited to body motion, facial expressions, and lip synchronization parameters.

The term “speech information” refers to data representing a sequence of words or phonetic units intended to be spoken by a virtual person and used as input to a speech synthesis program.

The term “speech synthesis program” refers to a software module executed by the processor or an external processing device that converts speech information into audio data representing synthetic speech.

The term “synthetic speech” refers to audio data generated by the speech synthesis program that simulates spoken language corresponding to speech information.

The term “display images” refers to visual output data, such as image frames or rendered scenes, representing the appearance and motion of a virtual person or related content on a display device.

The term “virtual person” refers to a computer-generated entity, such as an avatar or digital character, that is capable of visually and audibly presenting content through motion information and speech information.

The term “processing state information” refers to data indicating a status or progress of processing performed by the processor, including at least a creation state of distribution data or a creation state of a prompt sentence.

The term “terminal device” refers to an external computing device, such as a personal computer, a mobile device, or another user-operated device, that communicates with the server, receives data including processing state information and distribution data, and provides user interaction and display functions.

The term “output data from the generative information processing model” refers to any data, including summary data, important information data, educational material data, interactive response data, or response sentences, that is generated by the generative information processing model in response to input data and a prompt sentence.

The server implements the present invention by executing computer programs stored in a storage device and cooperating with a terminal operated by a user. The server includes at least one hardware processor, a non-transitory storage device such as a solid-state drive, and a communication device such as a wired or wireless network interface. The terminal includes a display, an input interface such as a keyboard or touch panel, a local storage, and a communication interface for connecting to the server via a network such as the Internet.

The server executes an operating system such as a general-purpose server operating system and runs application programs implementing media processing, speech recognition interfacing, feature transformation, search, prompt sentence generation, generative AI model interfacing, dialogue management, and virtual person rendering. In one embodiment, the server executes a media processing program that internally uses a media processing library such as FFmpeg. The media processing program operates on audio or video files stored in the storage device and performs container demultiplexing, codec decoding, resampling, and channel conversion to output a single-channel audio stream in a predetermined format such as 16 kHz linear PCM. The server stores this audio stream as an audio file in the storage device and associates metadata such as user identifier, file identifier, and time information in a structured data record in a database.

The server executes a speech recognition interfacing program that transmits the audio file or audio segments to a speech recognition engine. In one embodiment, the server uses a remote speech recognition service exposed as an API, and in another embodiment, the server executes a local speech recognition engine such as a neural network-based model. The server converts the audio data into a sequence of acoustic feature vectors, such as mel-frequency cepstral coefficients (MFCCs) or log-mel filterbank features, and supplies these features to an acoustic model implemented by a deep neural network. The neural network may have a stack of convolutional layers, recurrent layers such as long short-term memory units, and fully connected layers that output posterior probabilities over phonetic units. The server uses a decoding algorithm such as beam search with a language model to output a character sequence or subword sequence representing the recognized text. The server then converts this output into character information encoded in a standard character encoding such as UTF-8 and stores the character information in the storage device.

The server executes a text-formatting program that operates on the character information and time-aligned recognition results. The text-formatting program uses deterministic rules, such as insertion of paragraph breaks when a silence interval exceeding a threshold is detected or when a sentence-final punctuation symbol is recognized. The server normalizes character variants, unifies quotation marks, deletes explicit noise markers, and maps tokens such as numbers into a standardized textual form. The server outputs distribution data in one or more formats, such as a plain text file, a structured markup document, or a document file, and stores the distribution data in the storage device together with index data identifying portions of text by time range or semantic segment.

The server executes a feature transformation program that converts textual units in the distribution data into numerical representations. In one embodiment, the server divides the distribution data into segments such as sentences, paragraphs, or fixed-length token windows. The server applies a tokenization procedure that maps each segment into a sequence of integer token identifiers based on a vocabulary generated by a subword segmentation method such as byte pair encoding. The server applies an embedding function realized by a neural network encoder, for example a multi-layer transformer encoder, to map each token sequence into a vector in a high-dimensional continuous space. This vector is the numerical representation of the corresponding segment. The server stores these numerical representations along with references to the original segments in a search data set that may be implemented as a table in a database or as an index in a dedicated vector search engine.

The server executes a search program that calculates similarity between numerical representations. The search program receives a numerical representation of a question sentence and computes a similarity measure such as cosine similarity or inner product between the question vector and each vector in the search data set. The server selects segments whose similarity exceeds a threshold or belong to the highest-ranking group. This retrieval procedure is different from simple keyword search used in human-operated systems and enables the server to capture semantic similarity even when the words in the question differ from the words in the transcript. As a result, the server improves the precision and recall of relevant passage retrieval, which in turn improves the quality of responses generated by the generative AI model.

The server executes a prompt generation program that constructs a prompt sentence based on the distribution data and the retrieval result. The server uses a template that includes slots for instructions, user questions, and retrieved segments. For example, the server may generate a prompt sentence of the following form:

“Below is a set of excerpts from a lecture transcript and a user question. Using only the information in the excerpts, answer the question in a concise and accurate manner. Excerpts: [extracted segments]. Question: [user question].”

The server may also enable the user to supply custom instructions via the terminal and insert those instructions into the prompt sentence. In other examples, the user may compose prompt sentences manually based on the distribution data. The user operates the terminal to open a user interface of a generative AI service and may input one of the following prompt sentences:

“Below is the transcript of a lecture on the latest trends in AI technology. Please summarize the main points in bullet form, focusing on key technologies, recent research directions, and practical applications. Transcript: [paste full text here].”

“From the following lecture transcript about AI technology, extract the five most important insights and explain each in two or three sentences. Transcript: [paste full text here].”

“Using the following transcript of a training session on AI, create a structured training handout with sections: 1) Overview, 2) Key concepts, 3) Case studies, 4) Quiz questions with answers. Transcript: [paste full text here].”

The server may also generate similar prompt sentences automatically, without user intervention, by selecting appropriate instruction phrases according to the type of processing indicated in instruction information.

The server interacts with a generative AI model that implements a generative information processing model. In one embodiment, the generative AI model is a large language model based on a transformer architecture with multiple self-attention layers, feed-forward layers, and layer normalization. The generative AI model receives a tokenized form of the prompt sentence and computes contextual token embeddings by repeatedly applying attention operations over the token sequence. During inference, the model calculates a probability distribution over the next token at each generation step using a softmax function on the output of the final layer. The server repeatedly samples or selects tokens according to this distribution until an end condition is met. The server then decodes the generated token sequence into a response sentence, summary data, important information data, or educational material data. The server stores these generated data in the storage device and associates them with corresponding distribution data and metadata.

The server uses error functions and training procedures to improve the generative AI model and the feature transformation model during a training phase distinct from the inference phase. In one embodiment, the generative AI model is trained with a cross-entropy loss function on large corpora of text, and the weights of the neural network are updated using gradient-based optimization methods such as stochastic gradient descent or adaptive moment estimation. The server may perform fine-tuning on domain-specific training data to improve accuracy for lecture and training content. The feature transformation model may be trained with contrastive learning objectives, where the server minimizes the distance between vectors of semantically related segments and maximizes the distance between unrelated segments. By arranging positive and negative pairs in training, the server configures the search data set construction to reflect semantic proximity more accurately than simple lexical matching.

The server executes a dialogue program that uses a combination of retrieval and generative modeling to realize interactive question-and-answer sessions. The server receives a question sentence from the terminal, executes the feature transformation program on the question sentence to obtain a numerical representation, retrieves related information from the search data set, and generates a prompt sentence that includes both the question and the related information. The server then transmits this prompt sentence to the generative AI model and receives a response sentence. This architecture differs from conventional human-driven question-and-answer processes because the retrieval and prompt composition are carried out automatically based on numerical representations and similarity metrics, thereby improving the technical efficiency and scalability of interactive training.

The server executes a virtual person rendering program that transforms generated text into visual and audio output of a virtual person. The server generates speech information by mapping text tokens to phonetic units and temporal information, and inputs this speech information into a speech synthesis engine. The speech synthesis engine uses acoustic models such as neural vocoders to produce synthetic speech. In parallel, the server generates motion information by applying rule-based mappings and learned mappings from phonetic and prosodic features to facial expression parameters and body pose parameters. The server may use a parametric avatar representation where each frame is determined by a set of control parameters for mouth shape, eye movement, head orientation, and body joint angles. The server synchronizes the synthetic speech waveform and the motion parameters based on a shared time axis and renders display images of the virtual person on a graphics engine. The terminal receives the rendered video or a stream of animation commands and outputs the images and audio through a display and speaker. This combination of speech synthesis, motion synthesis, and synchronization forms a technical process that improves the efficiency and consistency of virtual instructor generation compared to manual video production.

The server manages data structures and internal modules in a way that enhances computer performance. The server uses index structures optimized for vector search such as approximate nearest neighbor indices to accelerate similarity computation. For example, the server may use hierarchical clustering, inverted file structures, or graph-based indices that reduce the number of distance calculations needed to retrieve relevant segments. By doing so, the server lowers response latency in question-and-answer sessions even when the search data set comprises a large number of segments. The server can also cache frequently requested numerical representations and retrieval results in a fast memory area, which reduces repeated computation overhead and improves throughput.

The server reduces communication load between the server and external generative AI provider systems by compressing prompt sentences and by selecting only the minimum necessary excerpts from the distribution data. Because the server performs local retrieval and segment selection using numerical representations, the server does not transmit the entire transcript in every query. Instead, the server transmits only those segments that are highly relevant to the user's question. This selective transmission decreases the size of request payloads, reduces network congestion, and accelerates end-to-end response times.

The server improves accuracy and robustness of processing by enforcing rule-based constraints in addition to learned models. For instance, the server may discard candidate retrieval results whose similarity score falls below a configurable threshold, or the server may limit the maximum length of a prompt sentence to a predefined token budget. The server may also apply post-processing rules on generated responses, such as consistency checks with retrieved passages, removal of hallucinated content that is not supported by the distribution data, and correction of formatting. These procedures are executed as deterministic algorithms on the generated text and retrieved text, and they enhance the reliability of the system beyond straightforward automation of human tasks.

The terminal enables the user to monitor processing states and to interact with the system in a technically meaningful way. The server generates processing state information that indicates, for example, whether media processing, speech recognition, feature transformation, generative AI inference, or virtual person rendering has completed. The server transmits this processing state information to the terminal. The terminal displays progress indicators, such as percentage completion or step names, and permits the user to request specific outputs, such as downloading distribution data or starting a virtual lecture playback, only after the corresponding processing stage is marked as complete. This coordinated control of user interface and server-side processing avoids inconsistent states and reduces the risk of user errors.

The user interacts with the system by selecting input media, requesting processing modes, optionally editing or reviewing automatically generated prompt sentences, and consuming outputs such as transcripts, summaries, interactive answers, and virtual lectures. However, the core technical processes described above are executed by the server using specific data structures, neural network models, similarity computation algorithms, and rendering pipelines. This configuration leads to measurable technical effects, including but not limited to reduced processing time for large volumes of lecture data, improved accuracy of question-answer retrieval due to vector-based semantic matching, improved consistency of virtual instructor behavior via synchronized motion and speech synthesis, and reduced network usage due to selective transmission of relevant segments.

The server can be implemented in multiple embodiments and variations. In one embodiment, the server uses a remote generative AI model hosted by an external provider and communicates via an application programming interface. In another embodiment, the server hosts the generative AI model locally on one or more accelerators such as graphics processing units. The feature transformation program and the generative AI model may share part of the neural network architecture, such as using a common encoder. In another variation, the server uses different feature transformation models specialized for different domains or languages and selects an appropriate model according to metadata of the distribution data. The speech recognition component may also be replaced with alternative models, such as end-to-end attention-based encoder-decoder models or recurrent neural network transducer models, while maintaining the overall pipeline structure.

The server may further incorporate additional optimization methods that improve the operation of the system as a computing apparatus. These methods may include batching of multiple requests for simultaneous processing to exploit vectorized operations on the processor or accelerator, incremental updating of the search data set when new transcripts are added, and adaptive selection of model configurations based on system load or latency requirements. By designing the system in this modular yet integrated manner, the server transforms raw public media into a machine-usable, searchable, and generative-AI-ready representation and uses that representation to realize automated, high-quality training experiences that could not be achieved by mere manual use of separate tools.

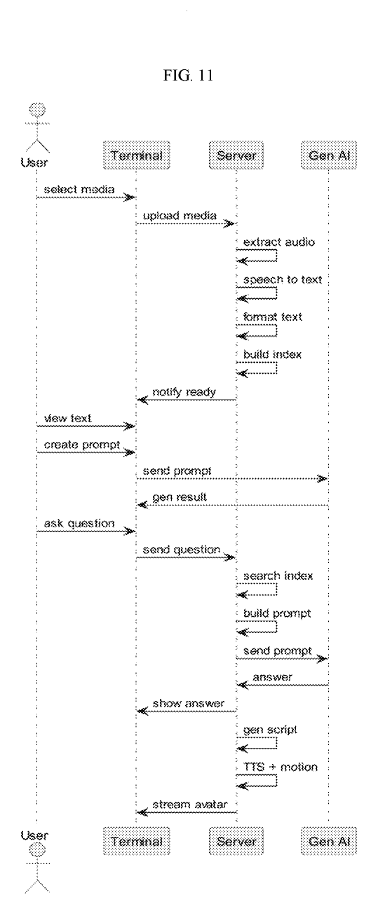

The following describes the processing flow using FIG. 11.

### Step 1

The user operates the terminal to select public media data as input. The user opens an application or web page on the terminal, browses the local storage, and selects one or more audio or video files (input: media file containing lecture or training content). The terminal reads the selected file from local storage and sends an upload request via a network to the server, including the media file and metadata such as file name and media type (output: uploaded media data transmitted to the server).

### Step 2

The server receives the uploaded media data as input via the communication device. The server writes the received media bytes to the storage device and records metadata such as file identifier, user identifier, and file path in a database (data processing: file I/O operations and database insert operations). The server outputs a stored media record (output: media file stored in the storage device and associated metadata record).

### Step 3

The server uses a media processing program as input handler for the stored media file. The server calls a media processing library such as a generic multimedia framework to open the media container and separate audio streams from any video streams (data processing: container demultiplexing and codec decoding). The server converts the audio stream to a normalized format (for example, 16 kHz, mono, linear PCM) and writes it as an audio file to the storage device (output: normalized audio file and updated metadata referencing the audio file).

### Step 4

The server uses the normalized audio file as input to a speech recognition program or an external speech recognition service. The server segments the audio into time windows if necessary, computes acoustic features such as mel-frequency cepstral coefficients, and sends the features or raw audio segments to an acoustic and language model (data processing: feature extraction, neural network inference, and decoding). The server receives recognized text segments, orders them by time, and concatenates them to form a transcript (output: raw character information representing recognized text and optional time stamps).

### Step 5

The server uses the raw character information as input to a text-formatting program. The server performs rule-based processing such as inserting line breaks at detected sentence boundaries, merging or splitting segments based on silence duration, normalizing symbols, and removing explicit noise markers (data processing: string manipulation and rule-based parsing). The server outputs distribution data in at least one machine-readable format, such as a plain text transcript file stored in the storage device and indexed by file identifier (output: formatted distribution data ready for retrieval and download).

### Step 6

The server uses the distribution data as input to a feature transformation program. The server divides the distribution data into units such as sentences or paragraphs, tokenizes each unit into subword tokens, and maps each token sequence into a numerical representation using a neural network encoder, for example a transformer-based embedding model (data processing: tokenization, embedding lookup, and forward propagation through the encoder network). The server stores the resulting vectors along with references to corresponding text units in a search data set (output: search data set comprising numerical representations and associated text segment identifiers).

### Step 7

The terminal uses the processing state information as input and notifies the user when the distribution data is ready. The user operates the terminal to download the transcript or open a result screen (input: user request for result). The terminal requests the distribution data from the server, receives the transcript file or structured text, and displays it on the screen (data processing: HTTP request/response handling and file rendering). The terminal outputs visible text to the user (output: displayed distribution data and optionally a local copy of the transcript file).

### Step 8

The user uses the displayed distribution data as input to create a prompt sentence. The user may manually select part or all of the transcript, copy the text, and construct a prompt sentence in a generative AI interface on the terminal. For example, the user may input:

“Below is the transcript of a lecture on the latest trends in AI technology. Please summarize the main points in bullet form, focusing on key technologies, recent research directions, and practical applications. Transcript: [paste full text here].”

The terminal sends this prompt sentence and any embedded transcript text to an external generative AI model server (output: prompt sentence transmitted to a generative AI model provider).

### Step 9

The server optionally generates a prompt sentence automatically as input for a generative AI model, without direct user editing. The server receives a question sentence from the terminal, converts the question sentence into a numerical representation using the feature transformation program, and calculates similarity between this vector and vectors in the search data set (data processing: vector similarity computation, such as cosine similarity). The server selects highly similar segments from the distribution data, concatenates them, and constructs a prompt sentence including instructions, the user’s question, and the extracted segments (output: automatically generated prompt sentence ready for submission to a generative AI model).

### Step 10

The server uses the generated prompt sentence and, optionally, the associated transcript excerpts as input to a generative AI model. The server tokenizes the prompt, sends the tokens to a generative model (such as a transformer-based language model), and executes inference, causing the model to compute attention weights, hidden states, and token probability distributions (data processing: forward pass through multiple neural network layers and probabilistic token selection). The server receives generated text such as summary data, important information data, educational material data, or an answer sentence (output: generated response data stored in the storage device and associated with the original media record).

### Step 11

The server uses the distribution data and the search data set as input to execute an interactive dialogue program. The server receives repeated question sentences from the terminal, converts each question into a numerical representation, retrieves related segments based on similarity, and composes new prompt sentences for the generative AI model (data processing: iterative retrieval and prompt construction). The server collects response sentences from the generative AI model and returns them to the terminal, allowing the user to view a sequence of question-and-answer pairs (output: interactive response data delivered as chat-style messages on the terminal).

### Step 12

The server uses generated summary data, important information data, or educational material data as input to a virtual person rendering pipeline. The server maps the text to speech information such as phoneme sequences and timing, sends this information to a speech synthesis engine, and receives synthetic speech audio (data processing: text-to-phoneme conversion and neural vocoder inference). In parallel, the server converts the speech timing and prosodic cues into motion information parameters for an avatar model, such as mouth shapes and facial expressions aligned to phoneme timings. The server synchronizes the audio and motion parameters on a common time axis and renders frames of a virtual person (output: audio-visual stream or video data of a virtual instructor stored or streamed to the terminal).

### Step 13

The terminal uses the audio-visual stream from the server as input and presents the virtual instructor to the user. The terminal decodes the video and audio data, displays the virtual person on the screen, and outputs the synthetic speech through speakers or headphones (data processing: decoding and synchronized playback). The user perceives an automated lecture or training session delivered by a virtual person (output: rendered lecture or training content in real time or from recorded media).

### Step 14

The server uses processing state information and user requests as input for system management. The server updates internal state flags indicating completion or failure of media processing, speech recognition, feature transformation, generative model processing, and virtual person rendering (data processing: state machine updates and logging). The server sends state updates to the terminal, which displays progress indicators and allows the user to trigger further actions, such as new question submissions or virtual lecture playback (output: up-to-date processing state information and corresponding user interface behavior).

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer‑implemented lecture and training support systems mainly focus on simple speech‑to‑text transcription or static subtitle display. In such systems, a processor typically converts audio into text and then presents the resulting text as subtitles or transcripts, without deeply integrating higher‑level language understanding, context‑aware summarization, or interactive dialogue generation. As a result, several technical problems remain unresolved from the perspective of computer technology.

First, existing systems are not architected to coordinate, in a unified processing pipeline, real‑time speech recognition, time‑synchronized text segmentation, generative AI processing with structured prompt sentences, and dynamic rendering of subtitles on heterogeneous display devices. When audio is long and complex, naïve transcription and display methods often cause latency, loss of temporal alignment between audio and text, and excessive data transfer between a server and user terminals. This leads to inefficient utilization of processing resources, increased network overhead, and degraded user experience, especially for users with hearing impairments or users in environments where audio cannot be clearly perceived.

Second, conventional systems do not effectively use generative AI models as core processing components in the pipeline. In typical designs, generative AI models are used in an ad‑hoc, offline manner, for example, to manually produce summaries or translations after a lecture has ended. The processor is not configured to systematically generate and manage prompt sentences that adapt to language, time segments, user preferences, and content type, nor to automatically orchestrate multiple generative AI tasks such as summarization, key point extraction, agenda generation, translation, and context‑constrained question answering. This results in redundant computation, inconsistent output formats, and difficulties in real‑time operation.

Third, current systems lack a tightly integrated mechanism for implementing fully automated training sessions, in which question‑and‑answer processing is handled end‑to‑end by machine processing. Conventional Q&A support often relies on static FAQ databases or simple keyword search over transcripts, without constraining generative AI models using precise prompt sentences and transcript‑based context. Consequently, generated answers may be inconsistent with the original lecture content, and the system fails to provide a reliable, scalable automated instructor that can respond to time‑position‑dependent user queries.

Fourth, known systems do not provide a unified computer‑implemented mechanism for generating multimodal educational presentation information, such as virtual person utterances, facial expressions, and motions, from the same intermediate representations that drive subtitles and summaries. Avatar or virtual person generation is often implemented as a separate application that manually consumes scripts, without direct linkage to time‑synchronized transcript segments, generative summaries, or per‑segment agenda data. This separation causes duplicated processing paths, manual conversion steps, and increased memory and storage usage.

Fifth, language handling in existing lecture support systems is generally static. When audio includes multiple languages, typical implementations use a fixed recognition and translation configuration. Processors do not dynamically determine the language of each recognized segment and do not switch prompt sentences or generative AI parameters per segment. This limitation causes recognition errors, inappropriate translations, and inefficient usage of generative AI resources, particularly in international conferences or multilingual training environments.

Sixth, the interaction loop between user terminals and the server is not optimized for fine‑grained, time‑position‑aware retrieval and generation. Conventional players can only present a fixed transcript or subtitles; when a user seeks to a particular time or requests additional explanation for a specific segment, the system does not use that time position as contextual input to a generative AI model. This leads to a technically inferior user interface, where the terminal cannot leverage server‑side AI processing to generate on‑demand, segment‑specific explanations or supplementary answers.

Therefore, there is a need for a computer‑implemented system in which a processor is specifically configured to integrate speech recognition, time‑aligned text processing, generative AI processing controlled by structured prompt sentences, automated Q&A, and virtual person generation into a coherent technical architecture. Such a system should improve processing efficiency, temporal alignment, adaptability to language and user preferences, and reliability of automated training, thereby enhancing the underlying computer technology for delivering accessible, interactive lecture and training experiences.

The specific processing by the specific processing unit 290 of the data processing device 12 in Application Example 1 is realized by the following means.

The present invention provides a server comprising a processor configured to acquire published video or audio content comprising an audio signal, convert the audio signal into character information by using a speech recognition‑based acoustic analysis unit, divide the character information into time‑segmented units based on time information, and generate input information including a structured prompt sentence for a generative AI model so as to cause the generative AI model to generate at least one of summary information, important information, agenda information, translation information, or response information from the time‑segmented character information; to input the input information to the generative AI model, store output information from the generative AI model in association with corresponding time segments, construct subtitle information from at least one of the character information or the summary information, and generate display control information for time‑series subtitle display on a display device based on a correspondence between the subtitle information and the video or audio content; to acquire question‑and‑answer information or operation information from a user terminal, determine a relevant time position and associated character information based on the acquired information, generate a prompt sentence for the generative AI model that constrains dialogue processing to the associated character information, and cause the generative AI model to generate additional explanation information or supplementary response information related to the relevant time position; and to generate at least one of utterance information, expression information, or motion information for a virtual person based on at least one of the character information, the summary information, or educational material information derived from the generative AI model, and to output integrated educational presentation information including the virtual person. This enables an integrated, time‑synchronized processing pipeline in which speech recognition, generative AI processing controlled by prompt sentences, dynamic subtitle generation, automated question‑and‑answer handling, and virtual person presentation are orchestrated by the processor, thereby improving computer‑implemented lecture and training support by reducing latency, enhancing temporal alignment, optimizing generative AI utilization, and providing a technically improved interactive learning interface.

The term “video information” refers to digital data representing visual content, including moving image sequences and any associated metadata suitable for playback on an electronic display.

The term “audio information” refers to digital data representing sound, including speech, music, and environmental sounds, and any associated metadata suitable for playback through an audio output device.

The term “audio signal” refers to an analog or digital representation of sound, including sampled waveform data or encoded audio frames, that can be processed by a computing device.

The term “acoustic analysis unit” refers to a hardware component, software component, or combination thereof configured to analyze an audio signal and extract linguistic features or phonetic content using speech recognition technology.

The term “speech recognition technology” refers to a set of algorithms and models that convert an audio signal comprising speech into corresponding character information representing recognized words or symbols.

The term “character information” refers to text data expressed as a sequence of characters, symbols, or code points representing linguistic content derived from audio information.

The term “time information” refers to data indicating temporal positions or durations within video information or audio information, including timestamps, frame indices, or time codes.

The term “time‑segmented units” refers to portions of character information or media content that are divided based on time information, such that each unit corresponds to a specific temporal interval.

The term “generative AI model” refers to a computational model, such as a neural network‑based language model, configured to generate new text or other content based on input data and learned parameters.

The term “prompt sentence” refers to a text string or set of instructions supplied as part of input information to a generative AI model, the text string or set of instructions specifying how the model should process given data and what kind of output should be generated.

The term “input information” refers to data supplied to a generative AI model, including at least one prompt sentence and associated content such as character information or metadata.

The term “summary information” refers to text data that concisely represents essential content extracted from more detailed character information while omitting less important details.

The term “important information” refers to text data representing key concepts, main points, or critical elements identified within character information as being of higher relevance.

The term “agenda information” refers to structured text data indicating sections, topics, or items that represent an outline or schedule for a lecture, training session, or presentation.

The term “translation information” refers to text data representing a linguistic transformation of character information from a first language into a second language.

The term “response information” refers to text data generated in reply to a question, query, or prompt, typically produced by a generative AI model using character information as context.

The term “output information from the generative AI model” refers to any data produced by the generative AI model in response to input information, including summary information, important information, agenda information, translation information, and response information.

The term “educational material information” refers to structured or unstructured text data generated or organized for use as learning materials, including handouts, explanations, examples, and practice content derived from character information or output information from the generative AI model.

The term “learning progress information” refers to data indicating a status, stage, or history of a user’s interaction with educational content, including completed sections, remaining sections, and suggested next steps.

The term “question‑and‑answer information” refers to data including at least one question and one corresponding answer, associated with specific content or time segments of video information or audio information.

The term “dialogue processing” refers to a computational procedure in which a system analyzes user input such as questions, generates corresponding system responses, and maintains conversational context over multiple turns.

The term “automated training process” refers to a computer‑implemented procedure that presents educational content and handles question‑and‑answer interactions without requiring a human instructor, using machine processing including a generative AI model.

The term “subtitle information” refers to structured text data comprising character information segments associated with time information for display in temporal alignment with video information or audio information.

The term “display control information” refers to data specifying how and when subtitle information or other textual content is to be presented on a display device, including timing, position, and formatting parameters.

The term “display device” refers to any electronic apparatus configured to present visual information, including monitors, television screens, mobile device screens, head‑mounted displays, and projection devices.

The term “virtual person” refers to a computer‑generated representation of a human or humanoid entity, including graphical, animated, or synthesized embodiments suitable for display on a display device.

The term “utterance information” refers to data representing spoken content for a virtual person, including phonetic sequences, text scripts, or synthesized speech parameters.

The term “expression information” refers to data representing facial expressions, eye movements, or other visual cues of a virtual person that convey emotional or conversational states.

The term “motion information” refers to data representing body movements, gestures, or posture changes of a virtual person over time.

The term “educational presentation information” refers to combined multimedia data including at least one of utterance information, expression information, motion information, subtitle information, or educational material information, formatted for presentation in an educational context.

The term “user terminal” refers to an electronic computing device operated by a user, including a smartphone, tablet, personal computer, or head‑mounted display, capable of communicating with the server and presenting information.

The term “operation information” refers to data representing user inputs received via a user terminal, including commands, control actions, time‑position selections, and configuration settings.

The term “time position” refers to a specific point in time within video information or audio information, designated relative to a start time, time code, or playback timeline.

The term “additional explanation information” refers to text data generated to further clarify, expand upon, or detail content associated with a particular time position or topic within the character information.

The term “supplementary response information” refers to response information generated in addition to an existing answer, providing further detail, clarification, or refinement based on additional input or context.

The term “published” refers to being made available to the public in a form that can be accessed by computing devices, including through communication networks, storage media, or streaming services.

In one embodiment, a server executes a lecture and training support program on general-purpose computer hardware. The server includes at least one multi-core central processing unit (CPU), a main memory, a nonvolatile storage device such as a solid-state drive (SSD), and a network interface connected to a communication network. The server runs an operating system such as a UNIX-like system and application software including a web server program, a speech recognition client library, a generative AI model client library, and a database management system. The server communicates with at least one terminal operated by a user. The terminal can be realized as a smartphone, a tablet, a notebook computer, or a head-mounted display and includes a display device, an audio output device, an input device, and a communication interface.

The server stores program modules in the nonvolatile storage device and loads them into the main memory for execution by the CPU. The program modules include at least an audio acquisition module, an acoustic analysis module, a transcript management module, a generative AI orchestration module, a subtitle generation module, a virtual person generation module, and a user interaction module. The server organizes audio, text, and metadata in explicit data structures, for example, an audio segment table, a transcript segment table, an AI task table, and a subtitle record table stored in a relational database such as PostgreSQL or MySQL.

The server uses existing speech recognition software as the acoustic analysis module. The server can employ, for example, an external speech recognition service provided through a network-based application programming interface (API). The server transmits audio signals in a standard format such as 16-bit linear pulse code modulation (PCM) at 16 kHz or 48 kHz, encoded in containers such as WAV or FLAC. The speech recognition service returns character information encoded as text, together with confidence scores and time stamps for recognized words or phrases. The server then parses the returned recognition results and stores each recognized segment as a record including fields such as start time, end time, recognized text, and confidence.

The server performs preprocessing of the audio signal prior to speech recognition. The server uses an audio processing library, such as a media framework, to convert arbitrary media formats (for example, MP4, MKV, MP3) into the required linear PCM format. The server divides the audio into fixed-length segments, for example, segments of 30 seconds, and assigns a unique segment identifier and a base time offset to each segment. The server maintains an audio segment table where each entry links the segment identifier to the base time offset, the file path, and the associated lecture identifier. This segmentation reduces the maximum size of a single recognition request and enables parallel processing across CPU cores, thereby reducing overall recognition latency.

The server constructs and manages character information as sequences of Unicode code points. The server normalizes the character information using text normalization routines, such as Unicode normalization form C, and optionally removes filler expressions based on language-dependent rules stored in a rule table. The server associates each normalized text unit with start and end times taken from the acoustic analysis result, resulting in a transcript segment table that can be indexed by time. This explicit association between time and text enables the server to quickly retrieve transcript segments corresponding to arbitrary playback positions without scanning entire files, thereby reducing processing time for seeking operations.

The server uses a generative AI orchestration module to interact with a generative AI model. The server can connect to an external generative AI model service implementing a transformer-based neural network language model. The generative AI model internally includes multiple layers of self-attention and feed-forward sublayers, positional encoding, and learned token embeddings. The generative AI model is trained using supervised and unsupervised learning on large corpora of text by minimizing a cross-entropy loss function between predicted token distributions and ground-truth next tokens. During training, the generative AI model updates weight parameters using gradient descent or a variant such as Adam, with backpropagation performed over mini-batches of token sequences. The server does not need to perform the training itself but uses the pre-trained weights and, optionally, fine-tuned variants optimized for summarization or question answering tasks.

The server structures input to the generative AI model as prompt sentences and contextual text. The server constructs a prompt sentence as a deterministic template text that instructs the generative AI model to perform a specific task, such as summarization, translation, agenda generation, or question answering, and includes parameters such as target language, maximum length, and output format. The server combines the prompt sentence with selected transcript segments to form input information. The server ensures that the combined input does not exceed a predetermined token limit of the generative AI model by computing an estimated token count and, if necessary, truncating or windowing the transcript segments.

The server stores prompt templates in a prompt table, where each record includes a template identifier, a task type (for example, “summarization” or “Q&A”), a base text string, and optional constraints such as “use bullet points” or “limit to 300 characters.” The server can instantiate the template by inserting actual content such as language codes and time ranges. This explicit template management allows the server to systematically control generative AI behavior in a repeatable manner, rather than relying on ad-hoc textual instructions.

The server can, for example, generate the following prompt sentence for translation and transcription:

“Convert the following English speech transcript into accurate Japanese text suitable as real-time subtitles. Keep sentences concise and easy to read. Transcript: […recognized English text…]”

The server can generate the following prompt sentence for summarization:

“Summarize the following lecture transcript in Japanese. Extract the main points for learners, use bullet points, and keep the total length within 300 Japanese characters. Transcript: […transcript text…]”

The server can generate the following prompt sentence for agenda creation:

“From the following training session transcript, create an agenda in Japanese that could be used to plan a 90-minute workshop. List 5–7 section titles in order, each with a one-sentence description. Transcript: […recognized text…]”

The server can generate the following prompt sentence for question answering:

“You are an expert instructor for this lecture. Answer the user’s question using only the information in the following transcript. If the answer is not clearly present, say that it is not available in the lecture. Transcript: […relevant transcript segment…] User question: […user’s question…]”

The server can generate the following prompt sentence for a virtual instructor persona:

“Act as a Japanese HR trainer explaining this material to new employees. Rewrite the following content in a friendly, spoken style, using simple Japanese and concrete examples. Content: […recognized or summarized text…]”

The server applies a consistent algorithm for constructing prompt sentences, including token counting, template selection, and domain-specific rule application. For example, when the server detects that audio includes multiple languages, the server performs a language determination process on each transcript segment using a language identification model. The server then selects a translation-oriented prompt template only when the detected source language and the user’s preferred display language differ. This conditional prompting avoids unnecessary translation operations, reduces processing load on the generative AI model, and minimizes network traffic between the server and the external AI service.

The server improves computer technology by performing time-aligned segmentation and caching of generative AI outputs. The server indexes each generated summary, agenda item, translation, or response by a time interval and stores the index in the AI task table. When the terminal later requests information for a time range, the server can return existing AI results directly instead of re-invoking the generative AI model. This caching reduces redundant computation and network calls, resulting in lower latency, lower bandwidth consumption, and improved scalability for many simultaneous users.

The server uses a specific data flow to generate subtitle information. The server first constructs a subtitle record for each transcript segment, containing fields such as segment identifier, start time, end time, text, and target language. The server then converts the subtitle records into a format suitable for streaming to the terminal, such as a structured text representation or incremental messages. The server maintains a sliding window over the current playback position and sends only subtitle records falling within this window to the terminal via a persistent connection such as a web socket. This sliding window mechanism reduces the amount of data transmitted at any given time and maintains tight synchronization between audio playback and subtitle display.

The terminal receives subtitle records and renders them using its graphical user interface framework. The terminal can, for example, map each subtitle record to a text element in a video player overlay. The terminal aligns display timing by comparing the current playback time of the media player with the start and end times associated with the subtitle record. When the current time enters the start time, the terminal displays the subtitle text; when the current time passes the end time, the terminal hides or replaces the subtitle text. This time-based rendering algorithm enables precise alignment between audio and subtitles across different terminal devices, despite local variations in decoding and rendering performance.

The server generates educational material information such as summaries and agendas by applying the generative AI model to larger transcript segments. The server stores the resulting text as structured entries in a material table, where each entry includes a section title, a description, and an associated time interval. The server can then use these structured entries both for static display in a “Summary” or “Agenda” view and as context for subsequent question answering. By linking agenda items to time intervals, the server allows the terminal to implement a “jump to section” function that seeks the media player to the start time of the selected agenda item. This linkage between generated structure and media timeline is not a direct analog of human summarization but a specific technical method that improves navigation performance and reduces user search time.

The user can interact with the system through the terminal. The user selects a lecture or training video, chooses preferred subtitle and interface languages, and enables or disables options such as summary display or virtual instructor mode. The terminal sends the user’s settings to the server as structured configuration data. The server stores the configuration data in a session table and uses it to influence prompt template selection, target languages, and output formats. For example, when the user prefers subtitles in a first language and summaries in a second language, the server generates separate sets of prompt sentences and instructs the generative AI model accordingly.

The server supports a fully automated question-and-answer function by combining transcript retrieval with generative AI processing. The server, upon receiving a question from the terminal, retrieves transcript segments that are most likely relevant to the question. The server can implement this retrieval using an index of term frequencies, inverse document frequencies, or vector representations obtained by encoding transcript segments into numerical feature vectors. The server then constructs a prompt sentence that includes the retrieved transcript segments and the user’s question and sends this input information to the generative AI model. The generative AI model, using its internal attention mechanism and learned parameters, computes a probability distribution over possible next tokens conditioned on both the transcript context and the question. The generative AI model then outputs a sequence of tokens representing a coherent answer. The server decodes the token sequence into text and returns it to the terminal as response information.

The server’s retrieval and prompting algorithm produces technical effects beyond a simple human-like Q&A. By constraining the generative AI model to a specific transcript subset and clearly instructing it to rely only on that subset, the server reduces the risk of generating content that is not supported by the source material. This constraint also reduces the amount of context that needs to be transmitted to and processed by the generative AI model, thereby reducing computational complexity and latency. The server thus improves the accuracy and reliability of automated answers and enhances resource efficiency compared to naïve use of generative AI over entire transcripts.

The server also generates virtual person output information. The server uses the generative AI model to transform transcript segments or summaries into utterance scripts tailored to spoken language style. The server then converts each utterance script into utterance information, including phoneme sequences and timing. The server can generate expression information and motion information for a virtual person by applying rule-based mappings from linguistic features to facial expressions and gestures. For example, the server can maintain a mapping table from sentiment indicators (such as “positive,” “neutral,” “warning”) to expression patterns (such as “smile,” “neutral face,” “serious face”). The server can also apply procedural animation algorithms to generate smooth transitions between poses. The server packages utterance, expression, and motion information into a data stream that can be rendered by a graphics engine on the server or on the terminal.

In one variation, the server executes a three-dimensional graphics engine that uses a programmable graphics processing unit (GPU) to render images of the virtual person. The server then encodes the rendered images and associated audio into a video stream and transmits the stream to the terminal. In another variation, the server transmits high-level animation parameters and scripts to the terminal, and the terminal renders the virtual person locally. In both cases, the server’s generation of synchronized utterance, expression, and motion information from AI-derived text enables a consistent, low-latency virtual instructor experience across devices, while leveraging GPU acceleration and efficient encoding methods.

The server can implement multiple alternative configurations for the generative AI model. In one embodiment, the server accesses an external model via an API. In another embodiment, the server hosts its own generative AI model on dedicated hardware. The server can store the model’s weight parameters on local storage and load them into GPU memory at startup. The server can implement a batch inference scheduler that groups multiple AI requests into a single batch to take advantage of GPU parallelism. This scheduler reduces the per-request processing overhead and increases throughput. The server can also implement caching of intermediate representations or key-value pairs in the transformer model’s attention mechanism for streaming tasks, enabling faster incremental decoding for long sequences.

The server enhances computer technology by making targeted use of these model-level optimizations. For instance, the server can reuse transformer attention caches when processing consecutive transcript segments from the same lecture, effectively treating the lecture as a single context window broken into overlapping chunks. This reuse reduces repeated computation for overlapping context and thus reduces inference time and energy consumption relative to recomputing from scratch for each request.

The server also implements error handling and quality control measures that improve the robustness of the system. The server monitors confidence scores from the speech recognition module and may request re-recognition of segments whose confidence falls below a threshold. The server can instruct the generative AI model to include uncertainty markers or to request clarification when the input transcript contains too many low-confidence segments. By incorporating such rules, the server avoids blindly trusting potentially inaccurate input and improves the quality of generated output.

The terminal provides a user interface that allows the user to control playback, subtitle appearance, and interaction with the automated instructor. The terminal can cache recently received subtitles, summaries, and answers to enable quick local redisplay without requesting the same data again from the server. This caching reduces network communication and improves responsiveness, particularly when the user frequently seeks backward and forward. The terminal can prefetch upcoming subtitles based on the current playback rate and buffer state reported by the media player, and can adjust the font size or color based on user settings, all while maintaining synchronization.

The described embodiments are not limited to any specific speech recognition engine, generative AI model provider, or graphics engine. The server can substitute any equivalent component that provides similar functional capabilities. For example, the server can use an alternative sequence-to-sequence neural model for translation tasks or a specialized question answering model fine-tuned on technical documentation. The server can also integrate additional modules, such as a domain-specific terminology dictionary, to guide both speech recognition and generative AI output.

In summary, the server coordinates multiple modules—acoustic analysis, transcript management, generative AI orchestration, subtitle generation, virtual person generation, and user interaction—to realize a technically integrated system. The system improves processing speed by segmenting and indexing data, improves accuracy by combining time-stamped transcripts with constrained generative AI prompts, reduces communication load through caching and incremental streaming, and provides an enhanced interactive learning interface that cannot be achieved by simple manual transcription and human-driven summarization alone.

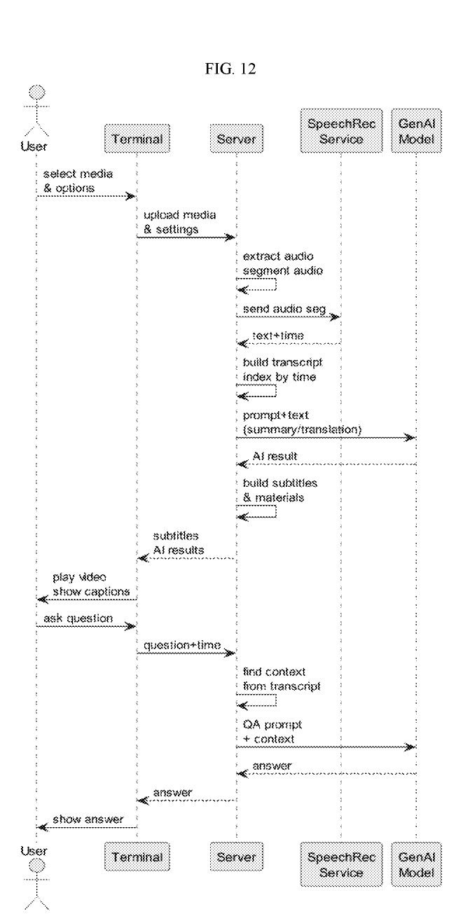

The following describes the processing flow using FIG. 12.

### Step 1

Server receives lecture or training media from the terminal as input. Server accepts an upload of a media file or a reference to published content (for example, a URL) and stores the received data on a storage device together with metadata such as media identifier, duration, codec, and user settings. Based on this input, server parses the media container, extracts an audio signal stream, and outputs a normalized internal representation that includes a file path to the extracted audio and basic audio attributes such as sampling rate and channel count.

### Step 2

Server converts the extracted audio signal into a uniform analysis format as input to the acoustic analysis module. Server invokes an audio processing library to decode compressed audio frames, resample the signal to a target sampling rate, convert it to a specific bit depth and channel configuration (for example, 16-bit PCM, mono, 16 kHz), and split the continuous stream into fixed-length segments (for example, 30 seconds each). Server stores each segment with a segment identifier and a base time offset, and outputs a set of audio segment records ready for speech recognition.

### Step 3

Server uses the audio segment records as input to a speech recognition service. Server transmits each segment, along with configuration parameters such as language code and encoding, to the speech recognition engine and waits for recognition results. Based on the returned recognition data, server parses the recognition output, extracts recognized text, confidence scores, and time stamps, and outputs a set of transcript segment records where each record includes segment identifier, start time, end time, recognized text, and confidence.

### Step 4

Server receives the transcript segment records as input and constructs a time-aligned transcript. Server concatenates segment-level text in chronological order, normalizes Unicode encoding, and applies language-specific cleanup rules such as removal of filler words or correction of spacing. Server calculates absolute time positions by adding base time offsets to segment-relative times and stores each sentence or phrase as a transcript unit associated with start and end times. Server outputs an indexed transcript structure that can be queried by time position and lecture identifier.

### Step 5

Server receives the indexed transcript and user configuration as input to determine processing tasks for the generative AI model. Server examines user preferences such as requested subtitle language, need for summaries, agendas, or translation, and divides the transcript into blocks that respect a predefined token limit for the generative AI model. For each block, server selects an appropriate prompt template (for example, summarization, translation, or agenda creation) and fills in parameters such as target language, length constraints, and style. Server outputs a set of AI task descriptors, each containing a prompt sentence and the associated transcript block.

### Step 6

Server uses each AI task descriptor as input to the generative AI model. Server sends the prompt sentence and transcript block to the generative AI service with inference parameters such as maximum token count, temperature, and sampling settings. Internally, the generative AI model processes the tokenized prompt and transcript using layered self-attention and feed-forward computations, generating output token sequences that represent summaries, translations, agenda items, or other requested text. Server receives the output text, verifies that it follows the requested format, and outputs AI result records linked to the corresponding transcript blocks and time ranges.

### Step 7

Server uses the AI result records and transcript structure as input to generate subtitle information. Server decides whether to use raw transcript text, translated text, or AI-refined text for subtitles based on user settings and language detection results. Server creates subtitle entries, each including a text string, a start time, and an end time, and may adjust line breaks and grouping to ensure readability on the terminal display. Server outputs a time-ordered list of subtitle entries and, when needed, converts them into streaming messages or subtitle file formats suitable for transmission.

### Step 8

Server uses user language preferences and, where applicable, multi-language transcript segments as input to perform language determination and adaptive prompt selection. Server applies a language identification algorithm to each transcript unit to classify its language and compares the detected language with the user’s display language. When the languages differ, server selects translation-oriented prompt sentences; when they match, server selects summarization or key point extraction prompts. Server then updates AI task descriptors accordingly and outputs optimized AI processing plans that avoid unnecessary translation and reduce overall processing load.

### Step 9

Terminal uses the subtitle entries and AI result records received from the server as input to render content for the user. Terminal synchronizes subtitle display with local media playback by comparing the current playback time with subtitle start and end times and draws the corresponding text onto an overlay area of the display. Terminal also presents summaries, key points, and agenda items in dedicated views, allowing scrolling, selection, and search. Based on these inputs, terminal outputs real-time visual content on the display device and may cache the displayed text locally for rapid redisplay.

### Step 10

User uses the controls provided by the terminal as input to select content, configure options, and navigate within the lecture. User chooses a lecture, specifies subtitle and interface language, and enables or disables generation of summaries, agendas, and virtual instructor functions. User also performs playback operations such as play, pause, seek, and section jump. Based on these user actions, terminal sends updated configuration and playback state to the server and outputs operation information that drives subsequent server-side processing and AI invocation.

### Step 11

User provides a natural language question through the terminal as input for automated question answering. User types or speaks a question related to a specific part of the lecture and, optionally, selects a time position or section corresponding to the question. Terminal converts spoken questions to text when necessary and sends the question text and optional time position to the server. Based on this input, terminal outputs structured question data associated with the active lecture session.

### Step 12

Server uses the structured question data and the indexed transcript as input to retrieve context for the generative AI model. Server identifies transcript units near the indicated time position or, if no time is provided, applies keyword or vector-based similarity search to find relevant transcript segments. Server aggregates the selected segments into a context block and constructs a prompt sentence that instructs the generative AI model to answer the user’s question using only the provided transcript context. Server outputs a question-answer AI task descriptor that includes the prompt sentence, the context block, and the user’s question.

### Step 13

Server uses the question-answer AI task descriptor as input to the generative AI model to generate response information. Server sends the prompt sentence, transcript context, and user question to the model, which computes an answer text sequence using its attention-based architecture. Server receives the generated answer, checks that it complies with constraints such as refraining from adding information not present in the transcript, and associates the answer with the question and relevant time intervals. Server outputs response records that encapsulate the final answer text and supporting transcript references.

### Step 14

Terminal uses the response records received from the server as input to present automated Q&A results. Terminal displays the answer text in a chat-style interface or an overlay, optionally with links or buttons that allow the user to jump to the related portions of the lecture. Terminal may also show the underlying transcript snippet used to derive the answer. Based on this input, terminal outputs interactive visual elements that enable the user to review and follow up on the automated answer.

### Step 15

Server uses the AI result records (summaries, agendas, translations) and transcript structure as input to generate educational material information. Server formats summaries and agendas into structured sections, associates each section with a time range, and optionally enriches them with additional explanation text generated by the generative AI model using dedicated prompt sentences. Server stores these materials in a material table and outputs a coherent set of educational resources that can be accessed by the terminal for later review or export.

### Step 16

Server uses educational material information and transcript segments as input to create utterance scripts for a virtual person. Server applies a style transformation using the generative AI model, guided by a persona-specific prompt sentence, to convert formal transcript text into more conversational spoken-style text. Server segments the resulting text into utterance units with associated timing constraints and outputs a sequence of utterance scripts that match the logical flow of the lecture.

### Step 17

Server uses the utterance scripts as input to derive utterance information, expression information, and motion information for a virtual person. Server converts each utterance script into phoneme sequences and estimated timing, and maps linguistic features or sentiment indicators to facial expression patterns and body gestures using predefined rule sets and mapping tables. Server then generates motion curves or keyframes for the virtual person model and outputs synchronized animation data that describes how the virtual person should speak and move over time.

### Step 18

Terminal uses the animation data and, in some embodiments, audio streams as input to render the virtual person for the user. Terminal executes a graphics engine or a rendering component that reads the utterance information, expression information, and motion information and generates real-time images of the virtual person on the display device, while playing corresponding audio through the audio output device. Based on this input, terminal outputs a virtual instructor presentation that is temporally aligned with the underlying lecture content and responsive to user-selected sections and questions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented training and education systems typically treat each processing stage in isolation: audio transcription, content summarization, material authoring, and question-and-answer handling are often executed as separate tools or manual workflows. In such systems, a processor merely outputs raw text from speech recognition, after which a human operator must manually select portions of the transcript, design prompts for a generative AI model, edit the generated results into structured documents, and script or supervise interactive sessions. As a result, the overall pipeline is fragmented, latency is high, and the system cannot adaptively reuse intermediate data such as transcripts, prompts, and Q&A logs for continuous improvement of the training experience.

Further, in many existing systems, generative AI models are invoked in a simplistic way, typically by submitting a single, static prompt and receiving a single, unstructured output. These systems fail to leverage the processor to coordinate multiple types of prompt sentences, output formats, and interaction states across the training lifecycle. For example, current systems do not systematically associate transcript identifiers, prompt sentences, and generated outputs in a persistent data structure that can be re-accessed by the processor to generate different types of training artifacts (summaries, key points, quizzes, study plans) from the same base content. This leads to redundant computation, inconsistent outputs, and difficulty in scaling the system to large volumes of training data.

Additionally, existing virtual instructor or avatar-based systems are often implemented as front-end presentation layers that merely play back pre-authored scripts or prerecorded audio. In such systems, the processor does not maintain a unified representation of character setting information, dialogue content, and Q&A information that is tightly coupled with the generative AI model’s input history. Consequently, the virtual instructor cannot reliably adapt to a trainee’s past interactions or to different training sessions without manual reconfiguration. The lack of an integrated control mechanism for synchronizing visual behaviors (expressions, gestures) with dynamically generated speech further reduces the realism and responsiveness of the system.

Moreover, in contemporary architectures, there is typically no processor-level mechanism to manage prompt evolution over time. A prompt sentence is generally supplied once by a user and is not automatically refined based on stored histories of prior inputs and outputs to the generative AI model. This prevents the system from learning from previous sessions, from automatically optimizing prompts for different output formats, and from tailoring the behavior of the generative AI model to specific training goals or trainee profiles. Thus, the computing resources are used inefficiently, and the model’s potential for context-aware adaptation remains underutilized.

Therefore, there is a need for a computer-implemented system in which the processor itself orchestrates: (i) end-to-end transformation of video information into structured training artifacts via coordinated use of speech recognition and a generative AI model; (ii) association and reuse of character information, prompt sentences, and generated outputs across multiple output formats; and (iii) continuous adaptation of a virtual person’s dialogue and behavior based on stored input histories. Such a system would constitute an improvement in computer technology by providing a processor-controlled, integrated, and stateful pipeline that reduces human intervention, improves consistency and responsiveness, and optimizes the use of generative AI within training environments.

The specific processing by the specific processing unit 290 of the data processing device 12 in Example 2 is realized by the following means.

The present invention provides a server comprising a processor configured to extract audio information from video information including publicly available information, convert the audio information into character information by using a speech recognition technology, store the character information in association with identification information, acquire the character information on the basis of the identification information, generate input information including the character information and a prompt sentence, and input the input information to a generative AI model so as to cause the generative AI model to generate summary information and important information; to convert the summary information and the important information into a predetermined document format or plan format, structure the converted information as distribution materials or schedule tables, and generate electronic documents including the structured information; to associate the character information and the prompt sentence with a plurality of kinds of output format designation information, cause the generative AI model to generate at least one of the summary information, the important information, question information, and learning plan information in accordance with the output format designation information, and perform output control by selecting different electronic document formats or interactive formats for each piece of the generated information; to generate character setting information and dialogue information of a virtual person on the basis of the character information and the summary information, input a prompt sentence for responding to the dialogue information to the generative AI model so as to cause the generative AI model to generate question-and-answer information, execute automatic response processing by an interactive program by using the question-and-answer information, and generate visual information and audio information of the virtual person on the basis of the character setting information and the question-and-answer information while synchronizing motion information and expression information as the visual information with voice synthesis information as the audio information; and to store the character setting information, the dialogue information, and the question-and-answer information in association with an input history to the generative AI model, and automatically generate or supplement a subsequent prompt sentence to the generative AI model on the basis of the input history so as to sequentially update dialogue content and behavior of the virtual person adapted to training content and response history of a trainee. This enables improvement of computer technology by providing an integrated, processor-controlled pipeline that efficiently transforms video-based training content into multiple structured outputs, manages prompt sentences and generated data as persistent state, and dynamically adapts a virtual instructor’s dialogue and behavior through coordinated use of speech recognition, generative AI, and interactive programs.

The term “video information” refers to digital data representing moving images, which may optionally include embedded audio information and which is stored in or streamed from an electronic storage medium.

The term “publicly available information” refers to information that is accessible to an unspecified or large number of users via a communication network or recording medium without requiring individualized authorization.

The term “audio information” refers to digital data representing sound, including speech, music, and environmental noise, that is encoded in an electronic format and processable by a computing device.

The term “speech recognition technology” refers to a software-implemented or hardware-implemented technique that analyzes audio information and outputs corresponding character information by mapping acoustic patterns to linguistic units.

The term “character information” refers to text data composed of symbols, letters, numerals, or other characters that represent linguistic content derived from audio information or other sources.

The term “identification information” refers to data used to uniquely or distinctly associate related pieces of information, such as an identifier assigned to character information, audio information, or generated output.

The term “prompt sentence” refers to text data that instructs a generative AI model to perform a particular operation, including summarization, information extraction, question generation, or dialogue generation.

The term “input information” refers to data provided to a generative AI model, the data including at least character information and a prompt sentence, and optionally including metadata such as format specification information.

The term “generative AI model” refers to a machine-learned model that receives input information including text and outputs generated content such as summary information, important information, question information, learning plan information, or dialogue information.

The term “summary information” refers to text data representing a condensed description of content contained in character information, with less detail than the original content and preserving main points.

The term “important information” refers to text data representing key points, essential facts, or priority items extracted from character information or summary information.

The term “document format” refers to a structural specification for electronic documents, including layout, headings, lists, and sections, suitable for representation in file formats such as text documents, presentation documents, or portable document files.

The term “plan format” refers to a structural specification for scheduling or planning data, including timelines, tasks, milestones, or learning activities arranged in a time-ordered or category-ordered manner.

The term “distribution materials” refers to electronic documents or data structures prepared for delivery to trainees or users, the documents including at least summary information and important information.

The term “schedule tables” refers to structured data representing temporal arrangements of training sessions, tasks, or learning activities, typically organized in tabular or calendar form.

The term “electronic documents” refers to data files or data objects representing formatted content, including text and optionally images or other media, that are stored and processed by electronic devices.

The term “output format designation information” refers to data indicating a requested output type or structure, such as a summary, bullet list, quiz, learning plan, or interactive dialogue format.

The term “question information” refers to text data representing interrogative statements or prompts intended to assess understanding, elicit responses, or form the basis of a quiz or dialogue.

The term “learning plan information” refers to structured text data describing a sequence of learning activities, objectives, and time allocations for training or education.

The term “output control” refers to processing that selects and applies a particular output format, presentation style, or delivery mode to information generated by a generative AI model.

The term “interactive format” refers to a configuration in which a user can exchange messages or actions with a system in a back-and-forth manner, including chat interfaces, virtual instructor sessions, or other dialogue-based interactions.

The term “virtual person” refers to a computer-generated entity that is assigned persona characteristics and is capable of presenting information or engaging in dialogue as a simulated human or character.

The term “character setting information” refers to data defining attributes of a virtual person, including role, expertise, speaking style, personality traits, and other parameters that influence dialogue and presentation.

The term “dialogue information” refers to text data representing utterances, scripts, or conversational flows used by a virtual person during interaction with a user.

The term “question-and-answer information” refers to text data including at least one question and at least one corresponding answer, generated or selected for use in automated dialogue or training.

The term “interactive program” refers to software that controls bidirectional communication with a user, including receiving user inputs and outputting system responses, based on predefined or generated dialogue information.

The term “visual information” refers to digital data representing images, animations, or graphical elements used to display the appearance, motions, or expressions of a virtual person.

The term “audio information of the virtual person” refers to digital data representing synthesized or recorded speech corresponding to utterances of the virtual person.

The term “motion information” refers to digital data defining movements of a virtual person, including body motion, gestures, and lip movements, to be rendered over time.

The term “expression information” refers to digital data defining facial expressions or other visual changes of a virtual person that convey emotional or communicative states.

The term “voice synthesis information” refers to digital data generated by a text-to-speech or similar process, representing audio signals corresponding to text utterances.

The term “input history” refers to a record of data previously input to a generative AI model, including past prompt sentences, character information, and generated outputs associated with one or more sessions.

The term “subsequent prompt sentence” refers to a prompt sentence that is generated or supplemented after an initial interaction, using the input history to refine or adapt instructions to the generative AI model.

The term “training content” refers to information, including lectures, explanations, examples, and exercises, that is used for educational or instructional purposes.

The term “response history of a trainee” refers to data representing past interactions of a trainee with the system, including answers, questions, selections, and other recorded responses.

In one embodiment, the system is implemented as a distributed computer system including at least one server and at least one terminal connected via a communication network. The server includes a processor, a memory, a non-transitory storage device, and a network interface. The terminal includes a processor, a memory, a user interface, an audio input device, a display, and a network interface. The server and the terminal execute a plurality of software modules that cooperate to perform audio extraction, speech recognition, natural language processing, document generation, and virtual instructor control.

The terminal uses a hardware platform such as a personal computer, a tablet device, or a smartphone including a central processing unit and, optionally, a graphics processing unit. The terminal executes an operating system such as a general-purpose desktop operating system or a mobile operating system. The terminal executes an application program, for example implemented as a web browser or a native application, that provides a graphical user interface for selecting video files, entering prompt sentences, previewing generated content, and interacting with a virtual person.

The server uses a hardware platform such as a virtual machine instance or a physical machine in a data center including at least one central processing unit and, in some embodiments, one or more graphics processing units. The server executes a server-side operating system and an application framework such as a server-side runtime environment or a web application framework. The server stores program instructions and data in a non-transitory computer-readable storage medium such as a magnetic disk, a solid-state drive, or a networked storage system.

The terminal receives video information from a storage device or from a streaming source. The terminal uses a media processing library, such as a multimedia framework, to separate an audio track from the video information and to generate audio information in a normalized format, for example a waveform format with a predetermined sampling rate and bit depth. The terminal transmits the normalized audio information to the server via a communication protocol such as HTTP over a packet network.

The server receives the audio information and stores it in a data store in association with identification information. The server invokes speech recognition technology to convert the audio information into character information. In one embodiment, the server calls an external speech recognition service by transmitting the audio information through an application programming interface. In another embodiment, the server executes a local automatic speech recognition engine including an acoustic model and a language model. The server decodes the audio information into a sequence of tokens representing phonetic units and then maps the tokens to character sequences using a decoding algorithm such as a beam search constrained by a statistical language model. The server generates transcript segments including time-stamp metadata, and stores the character information in association with the identification information in a structured data store such as a relational database or a document database.

The terminal displays a part of the character information to the user. The user reviews the displayed text and, if desired, corrects obvious recognition errors through an input interface. The terminal transmits correction data back to the server, and the server updates the stored character information and associated metadata. By maintaining corrected text and error statistics, the server can adjust language model weights or select an appropriate speech recognition engine in subsequent sessions, thereby improving recognition accuracy and reducing error rates over time.

The user enters at least one prompt sentence via a text input interface on the terminal. The prompt sentence instructs a generative AI model to perform specific operations. Examples of the prompt sentence include:

“Please summarize the following training transcript in 500 words and highlight all safety rules as bullet points.”

“Please extract the main learning objectives and create a 1-week study plan with daily tasks.”

“Generate a 10-question multiple-choice quiz based on this lecture, with four options per question and the correct answer clearly marked.”

“Play the role of an expert instructor and prepare opening remarks and closing remarks for this training session.”

The terminal associates the prompt sentence with the identification information of the corresponding character information and transmits this association to the server. The server creates input information including the character information, the prompt sentence, and output format designation information specifying, for example, whether the desired result is a summary, a bullet list, a quiz, a learning plan, or a dialogue script. The server structures the input information as a sequence of tokens suitable for the generative AI model.

The server implements the generative AI model as a trained neural network. In one embodiment, the generative AI model uses a transformer architecture including multiple encoder-decoder layers or decoder-only layers. Each layer includes multi-head self-attention modules, feed-forward neural network modules, normalization modules, and residual connections. The server stores model parameters including weight matrices, bias vectors, and layer normalization parameters in the memory. The server uses a tokenizer to segment the character information and the prompt sentence into discrete tokens, and then maps the tokens to numerical vectors by an embedding matrix. The server processes the numerical vectors through the layers of the neural network to compute output logits, and then converts the logits into probability distributions over the token vocabulary.

The server generates output tokens by applying a decoding algorithm, such as greedy decoding or beam search, that selects output tokens according to the probability distributions while enforcing constraints derived from the output format designation information. For example, when generating a bullet list, the server biases the output distribution towards line-break tokens and list markers. When generating quiz questions, the server biases the output distribution towards interrogative forms and answer option patterns. The server converts the output tokens back into characters to obtain summary information, important information, question information, learning plan information, or dialogue information. The server uses a loss function such as cross-entropy during training of the generative AI model and updates weights by a gradient-based optimization method such as stochastic gradient descent or an adaptive variant. The server optionally uses training techniques such as data augmentation, regularization, and curriculum learning to improve generalization and robustness.

The server stores the generated information in association with the identification information, the prompt sentence, and the output format designation information. The server thereby maintains an input history for each training session that includes the character information, the sequence of prompt sentences, and the resulting generated outputs. The server uses this input history to automatically generate subsequent prompt sentences. For example, the server analyzes the structure and content of previously successful prompt sentences that resulted in highly-rated outputs (as indicated by user feedback) and modifies new prompt sentences by inserting specific constraints, domain-specific terminology, or formatting instructions. This automatic supplementing of prompt sentences enables the system to iteratively refine the behavior of the generative AI model without requiring the user to manually experiment with prompt variations.

The server converts the summary information and the important information into predetermined document formats or plan formats. The server uses document generation modules to map structural elements such as headings, bullet lists, tables, and highlights to appropriate elements in target formats such as portable document file format, presentation file format, or spreadsheet format. The server organizes the summary information on introductory pages, arranges important information as bullet lists or tables, and places learning plan information into rows and columns representing days and activities. The server then generates electronic documents and stores file metadata, including storage location, file type, and access control information. The terminal retrieves file links from the server and displays them to the user for downloading or sharing.

The server generates character setting information for a virtual person. The server derives attributes such as role, expertise level, speaking style, and domain from the character information and the summary information. For example, when the training content relates to safety procedures, the server sets the virtual person as a “safety instructor” with a concise and directive speaking style. The server generates dialogue information, including scripted greetings, explanations, transitions, and closings, by using the generative AI model with a prompt sentence that instructs the model to produce persona-consistent utterances. The server stores the character setting information and the dialogue information in association with the identification information.

The server then generates question-and-answer information for use in interactive training. The server constructs prompt sentences that instruct the generative AI model to simulate questions likely to be asked by trainees and to provide corresponding answers based on the character information, the summary information, and the important information. The generative AI model, operating under these prompt sentences, generates pairs of questions and answers that are stored as structured data, including fields for question text, correct answer text, and optional explanation text. The server uses this structured Q&A information to support both static quiz generation and dynamic dialogue sessions.

The server generates visual information and audio information for the virtual person. The server creates a parameterized 2D or 3D model of the virtual person or selects a pre-defined avatar. The server defines motion information, including lip movement curves, head movement patterns, and gesture sequences, in a timeline that is aligned with the expected utterance timing. The server converts dialogue information into audio information by using a text-to-speech engine, which parameterizes phoneme durations and prosody. The server aligns phoneme timing data with facial animation parameters to synchronize lip movements and speech. The terminal receives the visual information and the audio information from the server and renders the avatar in real time using a rendering engine. The terminal plays back the audio information while animating the avatar according to the motion information and expression information.

The terminal also provides an input interface through which the user can pose questions to the virtual person in text form or by speech. When the user speaks, the terminal captures audio and, either locally or via the server, converts the audio into character information using speech recognition technology. The terminal transmits the user question, along with context information such as current training topic, previously displayed summary portions, and the current dialogue state, to the server. The server constructs a prompt sentence that instructs the generative AI model to respond as the virtual person in a manner consistent with the character setting information and the training content. The server feeds the prompt sentence and the question text into the generative AI model and generates answer text. The server stores this question-and-answer pair in the input history and updates the behavior of the virtual person by adjusting future prompt sentences and selecting suitable dialogue templates.

By maintaining structured input history and by automatically adapting prompt sentences, the server reduces redundant processing and improves computational efficiency. The server can reuse intermediate representations of the character information and previously generated key points instead of reprocessing the entire transcript for each new output type. The server maintains indexes over the character information, summary information, and important information, enabling efficient retrieval and partial recomputation. These optimizations reduce processing time and server load, thereby improving throughput and scalability when many training sessions are processed concurrently.

The described architecture improves computer technology in several ways. First, a unified data structure ties together character information, prompt sentences, output format designation information, and generated outputs so that the server can orchestrate multiple generations from a single base transcript without redundant data transfer or re-tokenization. This reduces communication overhead and computation cycles in comparison with separate, uncoordinated tools. Second, the server’s automatic prompt management mechanism uses prior input history as a feature space for selecting and adjusting prompt sentences, which results in more stable and predictable generative behavior without manual trial-and-error by the user. This improves the effective accuracy and consistency of generative outputs and reduces the need for repeated human supervision. Third, the integrated synchronization of text-to-speech timing and avatar motion information occurs through specific mapping algorithms from phoneme boundaries to animation parameters, which improves the alignment accuracy between audio information and visual information. This technical improvement leads to more realistic rendering and lower perceptual error in lip synchronization, which a human operator cannot reliably achieve manually in real time.

Furthermore, the server employs non-conventional processing flows that differ from mere human automation. For instance, the generative AI model is guided not only by the user’s explicit prompt sentence but also by system-generated control tokens that encode output structure, persona profile, and session state. The server inserts these control tokens into the token stream prior to inference to constrain and steer generation in a way that reduces undesired variability and off-topic responses. This use of structured control tokens and stateful history management constitutes a specific technical solution that leverages internal model mechanisms to achieve more efficient and accurate generation.

In alternative embodiments, the terminal may perform some of the processing steps instead of the server. For example, the terminal may locally execute a lightweight speech recognition engine and transmit only the resulting character information and metadata to the server, thereby reducing network bandwidth usage. In another variation, the terminal may cache frequently accessed summaries and key points so that the server does not need to recompute them for repeated sessions, further reducing server load and latency. In some embodiments, the generative AI model is deployed at the network edge or partially on the terminal, and the server coordinates segmented inference operations across devices to balance computational load and to reduce end-to-end response time.

In yet another embodiment, different types of generative models may be used depending on the requested output format. For example, a smaller, specialized model may be used to generate structured tables of learning plans, while a larger, more expressive model is used to generate free-form dialogue content. The server dynamically selects an appropriate model instance based on the output format designation information and the length of the character information. This selective model routing reduces unnecessary computation and supports real-time interaction even on devices with limited resources.

By combining these software modules and hardware configurations, the server, the terminal, and the user cooperate to implement the invention in a manner that is concrete, technically specific, and reproducible. The system does not merely automate a human workflow at a high level but modifies and improves the way computers manage and process training content by introducing specialized data structures, stateful prompt management, and coordinated control of generative AI output with multimodal rendering.

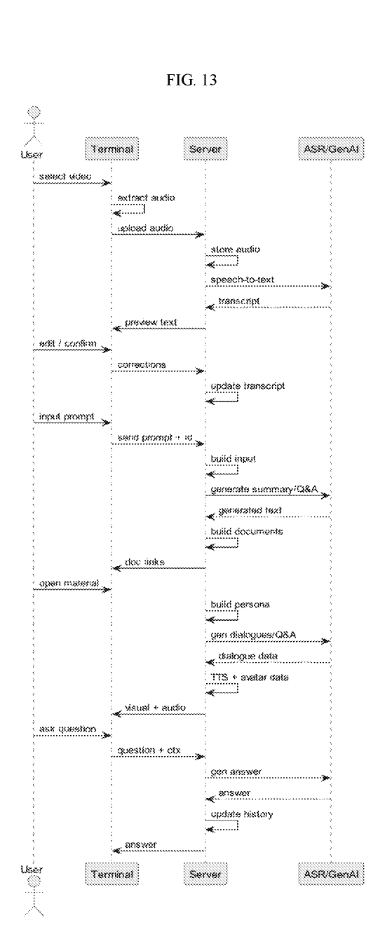

The following describes the processing flow using FIG. 13.

### Step 1

The user selects video information on the terminal.

The terminal receives, as input, a file path or stream identifier of the video information.

The terminal uses a media processing library to decode the video information, extract an embedded audio track, and normalize the audio information to a predetermined format (for example, waveform audio with a fixed sampling rate and channel configuration).

The terminal outputs normalized audio information and associated identification information (such as a temporary audio ID) to be transmitted to the server.

### Step 2

The terminal transmits the normalized audio information and the identification information to the server via a network interface.

The server receives, as input, the audio information and the identification information.

The server stores the audio information in a storage device while associating it with the identification information in a database record.

The server outputs a confirmation that the audio information has been stored and maintains a mapping between the identification information and the stored audio file location.

### Step 3

The server applies speech recognition technology to the stored audio information.

The server receives, as input, the audio information and the identification information.

The server performs feature extraction on the audio information (for example, computing Mel-frequency cepstral coefficients or other acoustic features), applies an acoustic model and a language model, and executes a decoding algorithm to convert the sequence of audio features into a sequence of character tokens.

The server outputs character information representing a transcript of the audio information and stores the character information in association with the identification information in a structured data store.

### Step 4

The terminal requests a preview of the character information from the server.

The server receives, as input, the identification information from the terminal.

The server retrieves the corresponding character information from the data store, optionally truncates it to a preview length, and formats it for display.

The server outputs preview text to the terminal.

The terminal displays the preview text to the user and outputs, as optional feedback, user-generated corrections or confirmations back to the server.

### Step 5

The user reviews the previewed character information on the terminal.

The user inputs corrections or confirms the accuracy of specific segments through a text editing interface.

The terminal receives, as input, the edited text segments and their positions within the character information.

The terminal outputs correction data to the server.

The server updates the stored character information by replacing or augmenting the corresponding segments based on the correction data and outputs updated character information in the storage.

### Step 6

The terminal prompts the user to enter a prompt sentence.

The user inputs at least one prompt sentence such as “Please summarize the following training transcript in 500 words and highlight all safety rules as bullet points.”

The terminal receives, as input, the prompt sentence and the identification information of the character information.

The terminal associates the prompt sentence with the identification information and outputs this association to the server.

### Step 7

The server constructs input information for a generative AI model.

The server receives, as input, the identification information and the prompt sentence from the terminal.

The server retrieves the corresponding character information from the data store and combines the character information with the prompt sentence and output format designation information into a unified data structure.

The server converts this unified data structure into token sequences by applying a tokenizer, and outputs tokenized input information suitable for processing by the generative AI model.

### Step 8

The server executes the generative AI model to generate derived information.

The server receives, as input, the tokenized input information.

The server processes the tokens through layers of a neural network architecture (including embedding, self-attention, and feed-forward operations), computes output logits for each token position, and applies a decoding algorithm (such as greedy decoding or beam search) to produce output token sequences.

The server converts the output token sequences back into character form to obtain summary information, important information, question information, learning plan information, or dialogue information according to the output format designation information.

The server outputs generated text data and stores it in association with the identification information and the prompt sentence.

### Step 9

The server structures the generated information into document or plan formats.

The server receives, as input, the generated text data and format designation information (for example, summary document, bullet-list handout, quiz, or schedule table).

The server parses the generated text into logical sections (headings, paragraphs, bullet lists, question-answer pairs, schedule entries) and maps these sections into target document structures (such as pages, slides, or table cells).

The server outputs structured data representing electronic documents, including layout specifications, and stores corresponding files in a storage device.

### Step 10

The terminal obtains links or identifiers for the generated electronic documents from the server.

The terminal receives, as input, document metadata (such as file names, types, and storage locations) from the server.

The terminal updates a user interface to list the generated documents and enables selection for download or viewing.

The terminal outputs selected documents to display modules or external applications so that the user can view, print, or distribute the materials.

### Step 11

The server generates character setting information for a virtual person.

The server receives, as input, the character information and the summary information associated with the identification information.

The server analyzes domain-specific terms and roles in the character information (for example, identifying that the content relates to safety training), assigns attributes such as role, expertise level, and speaking style, and stores these attributes as character setting information.

The server outputs structured character setting information that defines the persona of the virtual person.

### Step 12

The server generates dialogue information for scripted interaction.

The server receives, as input, the character setting information, the summary information, and a prompt sentence instructing generation of instructor-style dialogue (for example, “Play the role of an expert instructor and prepare opening remarks and closing remarks for this training session.”).

The server tokenizes the combined input, processes it through the generative AI model, and generates output tokens representing greeting messages, explanations, transitions, and closing messages.

The server converts these output tokens into text, divides the text into dialogue segments, and outputs dialogue information associated with the virtual person.

### Step 13

The server generates question-and-answer information for interactive training.

The server receives, as input, the character information, the summary information, and a prompt sentence instructing generation of question-and-answer pairs (for example, “Generate a 10-question multiple-choice quiz based on this lecture, with four options per question and the correct answer clearly marked.”).

The server feeds the input through the generative AI model, which produces text containing questions, answer options, and correct answer indicators.

The server parses the generated text into structured records, each including a question field, multiple option fields, and a correct answer field, and outputs the resulting question-and-answer information.

### Step 14

The server prepares visual information and audio information for the virtual person.

The server receives, as input, the character setting information, the dialogue information, and the question-and-answer information.

The server calls a text-to-speech engine to convert each dialogue segment and answer text into synthesized audio, and obtains phoneme timing and prosody data.

The server generates motion information and expression information by mapping phoneme timing and emphasis markers to facial animation curves and gesture sequences, and associates these with an avatar model.

The server outputs synchronized visual information and audio information for rendering on the terminal.

### Step 15

The terminal renders the virtual person and executes interactive dialogue.

The terminal receives, as input, the visual information and the audio information for the virtual person.

The terminal loads the avatar model, applies motion and expression parameters frame by frame, and plays back the corresponding synthesized audio in synchrony.

The terminal outputs a real-time visual representation of the virtual person and audible speech to the user.

### Step 16

The user interacts with the virtual person through questions or commands.

The user inputs, as input, spoken or typed questions using the terminal interface.

The terminal captures the spoken audio, converts it into character information using a speech recognition function (either locally or via the server), and associates the question with current session context such as the active topic and recent dialogue turns.

The terminal outputs the user question and context data to the server.

### Step 17

The server generates dynamic answers from the virtual person.

The server receives, as input, the user question, the context data, the character setting information, and the question-and-answer information.

The server constructs a context-aware prompt sentence that instructs the generative AI model to respond as the virtual person, incorporates relevant key points and prior answers, and tokenizes the combined context.

The server runs the generative AI model to produce answer text, optionally referencing stored question-and-answer information to ensure consistency and correctness, and outputs the generated answer text.

### Step 18

The server updates input history and adapts subsequent prompt sentences.

The server receives, as input, the user question, the generated answer text, and session metadata.

The server stores this interaction as part of an input history linked to the identification information and the virtual person.

The server analyzes patterns in the input history and adjusts parameters or templates used to construct future prompt sentences, for example by emphasizing frequently misunderstood topics or by modifying the level of detail in explanations.

The server outputs updated configuration data that will modify how subsequent prompt sentences are constructed and how the generative AI model is invoked.

### Step 19

The terminal presents the generated answer and continues the session.

The terminal receives, as input, the generated answer text and, when applicable, synthesized audio and updated motion information from the server.

The terminal displays the answer as text in a dialogue window and optionally plays back the synthesized audio while animating the virtual person accordingly.

The terminal outputs the updated dialogue state to the user, enabling further iterative questions and responses within the same training session.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer‑implemented training and guidance systems, including e‑learning platforms, digital manuals, and conversational agents, suffer from several technical limitations when processing large volumes of audio‑visual information and delivering it to end users in real time.

First, when a computing system attempts to utilize publicly available audio or video information, such as lectures, training sessions, or operation demonstrations, the system typically performs a unidirectional conversion from speech to text and optionally stores the text as a static transcript. These systems generally do not employ a coordinated pipeline in which a processor automatically extracts audio from heterogeneous media formats, converts the audio to character data, generates structured summaries and key information through a generative AI model using explicitly constructed prompt sentences, and then feeds the results back into multiple downstream modules. As a result, the system cannot efficiently transform raw audio‑visual data into structured, machine‑consumable knowledge that is suitable for dynamic rendering on various terminals, such as head‑mounted displays, portable terminals, or work‑support devices. This leads to high computational overhead for manual post‑processing, poor scalability, and delays in delivering relevant information to users in time‑critical environments such as factories or training sessions.

Second, existing question‑and‑answer automation in training systems is often decoupled from the underlying content generation logic. Many dialog systems or chatbots treat questions in isolation, without systematically leveraging a generative AI model that has been guided by carefully designed prompt sentences, informed by pre‑computed summaries, key points, and domain‑specific knowledge. Consequently, these systems either rely on rigid rule‑based responses or shallow retrieval‑based answers, which limits the quality, contextual relevance, and adaptability of automated question‑and‑answer processing. Moreover, they typically do not provide an end‑to‑end mechanism in which a processor builds and refines prompt‑sentence templates over time based on user interactions and operation histories, so that the generative AI model can be progressively optimized for the particular training or operational domain.

Third, conventional systems for adaptive training or customer assistance rarely integrate emotion recognition as a first‑class technical control signal within the content‑generation pipeline. While some systems may log user reactions or provide coarse feedback loops, they generally do not implement a processor that acquires facial‑expression images and voice data from a terminal, estimates a user emotional state using image analysis and voice analysis, and then constructs new prompt sentences that explicitly encode the emotional state as a parameter for the generative AI model. Without this integration, the system cannot technically adjust, in real time, a difficulty level, a detail level, or an expression style of the generated content in an automated and reproducible way. This results in inefficient use of computational resources, because content is generated in a one‑size‑fits‑all manner, requiring additional manual curation, and fails to exploit the generative model’s capabilities to tailor output to actual user states.

Fourth, although digital avatars and virtual persons are known, they are typically generated and controlled by separate pipelines that are not tightly coupled with content generation and emotion‑aware adaptation. Known solutions often pre‑render animations or manually script avatar behavior, which prevents real‑time synchronization between generated educational or explanatory content and avatar expressions or gestures. There is no unified processor that analyzes video data of a specific person, learns facial and motion features, generates a controllable virtual‑person model, and drives that model in direct synchronization with content produced by a generative AI model. As a consequence, avatar behavior is relatively static and disconnected from the dynamic, AI‑generated content and the recognized emotional state of the user, which reduces the effectiveness and responsiveness of the user interface.

Fifth, in both virtual and physical environments such as virtual stores or in‑store clerk‑assistance scenarios, existing systems provide only limited technical support for dynamically adjusting explanation content and customer‑service scripts based on user emotion and interaction history. Conventional systems often employ fixed scripts or simple recommendation rules, without using a processor that unifies: (i) multi‑modal input capture (audio, video, emotion), (ii) prompt‑driven use of a generative AI model for content generation, and (iii) continuous update of prompt‑sentence construction rules based on evaluation information and operation‑history information. Therefore, such systems cannot efficiently generate, in real time, tailored explanations and interaction scripts that match user interest, hesitation, or confusion, and cannot scientifically improve the underlying generative behavior over time.

Accordingly, there is a need for an improved computer‑implemented system and server architecture that: (1) efficiently converts large amounts of public audio or video information into structured, generative‑model‑ready data using automated prompt sentence construction; (2) tightly integrates a generative AI model into a full training and guidance pipeline including automated question‑and‑answer processing; (3) uses emotion recognition as an operational control signal for adjusting content difficulty, detail, and style; (4) synchronizes a virtual‑person model with dynamically generated content; and (5) automatically refines prompt‑sentence rules and content‑generation conditions based on user feedback and operation histories. Such a system improves the functioning of the computer itself by reducing redundant manual intervention, increasing the efficiency and relevance of content generation, and enabling adaptive, low‑latency interactions across heterogeneous terminals.

The specific processing by the specific processing unit 290 of the data processing device 12 in Application Example 2 is realized by the following means.

The present invention provides a server comprising a processor configured to acquire public audio information or video information from one or more data sources, to extract an audio signal from the audio information or the video information, and to convert the audio signal into character data by using a speech recognition technique; to construct, in accordance with a type of content and a use purpose of the character data, a prompt sentence for causing a generative information processing model to generate at least one of summary information, important information, procedure information, and meeting‑progress information, to input the prompt sentence and the character data to the generative information processing model, and to cause the generative information processing model to execute natural language processing to generate summary data and important‑information data; to generate, on the basis of the summary data and the important‑information data, at least one of educational display content, work‑support display content, agenda information, procedure information, and question‑and‑answer knowledge information, and to transmit the display content to a terminal so that the display content is sequentially displayed on a visual display apparatus of the terminal; to receive a question inputted by a user or question text transmitted from the terminal, to construct a prompt sentence on the basis of the question text and the question‑and‑answer knowledge information, to input the prompt sentence to the generative information processing model, to cause the generative information processing model to generate answer text, and to provide the answer text to the terminal via an interactive information processing program or a question‑answer information processing program so as to automate a question‑and‑answer process; to acquire facial‑expression image data and voice data of the user transmitted from the terminal, and to estimate an emotional state of the user by using an image analysis technique and a voice analysis technique; to construct, on the basis of the emotional state and at least one of the summary data and the display content, a prompt sentence for adjusting at least one of a difficulty level, a detail level, and an expression style of lecture content, explanation content, and work procedure content, to input the prompt sentence to the generative information processing model, to cause the generative information processing model to generate adjusted content data corresponding to the emotional state, and to transmit the adjusted content data to the terminal so that the adjusted content data is output as a display or audio from the terminal; to analyze video data indicating a specific person, to learn facial features and motion features, to generate a virtual‑person model whose facial expression and motion are controllable in synchronization with content data generated by the generative information processing model, and to cause the virtual‑person model to be displayed on a display screen or a virtual‑space display apparatus of the terminal; to present product information or service information in a virtual space or a real space via the virtual‑person model or a digital person, to dynamically adjust explanation content and a customer‑service script on the basis of the emotional state and explanation‑content data generated by the generative information processing model, and to output the explanation content and the customer‑service script to the terminal; and to acquire evaluation information or operation‑history information from the user, to update a construction rule of the prompt sentence and a content‑generation condition on the basis of the evaluation information and the operation‑history information, and to automatically adjust the prompt sentence to be used for subsequent input to the generative information processing model. This enables an improvement in computer technology by providing an integrated, processor‑implemented pipeline that transforms heterogeneous audio‑visual inputs into structured, emotion‑aware, and dynamically adaptable content using generative AI models and prompt sentences, thereby enhancing processing efficiency, reducing manual intervention, and allowing real‑time, context‑appropriate guidance and interaction across multiple types of terminals.

The term “public audio information or video information” refers to audio data or video data that is accessible to multiple users via a communication network or storage medium and that includes speech, lecture content, training content, operation demonstrations, or similar instructional or explanatory material.

The term “audio signal” refers to a time‑varying electrical or digital representation of sound, including human speech, extracted from audio data or from an audio track of video data.

The term “character data” refers to textual information represented as a sequence of characters in a machine‑readable format, obtained by converting audio signals or other data into text.

The term “speech recognition technique” refers to a computational method or algorithm that analyzes audio signals and outputs corresponding character data representing recognized words, phrases, or sentences.

The term “type of content” refers to a classification of the character data or generated data according to intended use or semantic category, such as educational content, training content, work‑procedure content, meeting content, or product‑explanation content.

The term “use purpose” refers to an intended application or function of the data, including but not limited to summarization, procedure guidance, agenda generation, question‑and‑answer support, or customer assistance.

The term “prompt sentence” refers to one or more machine‑interpretable natural‑language instructions constructed by a processor to guide a generative information processing model to perform a specified task on given input data.

The term “generative information processing model” refers to a computational model that receives input data and produces new information, such as summaries, explanations, procedures, or answers, by executing natural language processing or related data‑generation operations.

The term “summary information” refers to condensed textual content that captures main ideas or essential points extracted from larger bodies of input information.

The term “important information” refers to elements of content that are determined to be particularly relevant or critical for understanding or performing a task, such as key concepts, warnings, or decision points.

The term “procedure information” refers to structured data describing ordered steps or actions to be executed to complete a task, operation, or process.

The term “meeting‑progress information” refers to structured data that organizes content of a meeting or session into an agenda, schedule, or sequence of topics and time allocations.

The term “summary data” refers to machine‑stored data representing summary information generated by the generative information processing model.

The term “important‑information data” refers to machine‑stored data representing important information extracted by the generative information processing model.

The term “educational display content” refers to visual or audiovisual information configured for display to a learner for educational purposes, including summarized explanations, examples, and key points.

The term “work‑support display content” refers to visual or audiovisual information configured for display to a worker to support execution of work tasks, including procedures, cautions, and contextual hints.

The term “agenda information” refers to structured data defining sections, titles, and timing of topics for a meeting, training, or lecture.

The term “question‑and‑answer knowledge information” refers to structured data that associates questions with corresponding answer content, usable for automated question‑and‑answer processing.

The term “terminal” refers to an information processing device, such as a head‑mounted display apparatus, portable information terminal, or work‑support apparatus, that communicates with a server and presents content to a user.

The term “visual display apparatus” refers to a hardware component capable of visually presenting images or text to a user, such as a flat panel display, head‑mounted display, or projection unit.

The term “interactive information processing program” refers to software configured to manage dialog‑like exchanges with a user by receiving user inputs and providing responses.

The term “question‑answer information processing program” refers to software configured to receive question inputs and output answer content, optionally by invoking or interfacing with a generative information processing model.

The term “question text” refers to character data representing a user question, obtained from user input or a terminal.

The term “answer text” refers to character data representing an answer generated by a generative information processing model in response to a question text.

The term “facial‑expression image data” refers to image data or frame data capturing at least a portion of a user’s face suitable for analysis of facial expressions.

The term “voice data” refers to digital data representing sound produced by a user, including speech signals recorded by a microphone.

The term “image analysis technique” refers to a computational method for processing and analyzing image data to detect features, patterns, or attributes such as facial landmarks or expressions.

The term “voice analysis technique” refers to a computational method for processing and analyzing voice data to detect features such as pitch, intensity, and prosody, and to derive attributes including emotional state.

The term “emotional state” refers to an estimated condition of user affect, such as joy, confusion, sadness, interest, or anxiety, inferred from facial‑expression image data, voice data, or other signals.

The term “lecture content” refers to explanatory or instructional information provided in a structured form for teaching a topic, including verbal explanations, examples, and commentary.

The term “explanation content” refers to descriptive or clarifying information generated to help a user understand a concept, operation, or product.

The term “work procedure content” refers to content that describes task steps or methods used to perform an operation or job in a work environment.

The term “difficulty level” refers to a degree of complexity of content, such as sophistication of terminology, conceptual depth, or problem hardness.

The term “detail level” refers to an amount of information or granularity provided in the content, including how many steps, sub‑steps, or explanations are included.

The term “expression style” refers to characteristics of wording or presentation of content, such as formality, technicality, length of sentences, or use of analogies.

The term “adjusted content data” refers to data representing content that has been modified by the generative information processing model in accordance with a user’s emotional state or other control parameters.

The term “specific person” refers to an identifiable individual whose appearance and motion characteristics are used as a basis for generating a virtual‑person model.

The term “facial features” refers to measurable characteristics of a face, including shapes and positions of eyes, nose, mouth, and other facial components.

The term “motion features” refers to characteristics of movements, such as head gestures, facial expression dynamics, or body motions over time.

The term “virtual‑person model” refers to a data structure and associated control information describing a computer‑generated person whose facial expressions and motions can be programmatically controlled.

The term “virtual‑space display apparatus” refers to a device or combination of devices capable of rendering a virtual three‑dimensional environment, such as a head‑mounted display or a projection‑based system.

The term “digital person” refers to a computer‑generated human‑like character capable of presenting information or interacting with a user via visual or audiovisual output.

The term “product information” refers to data describing characteristics, specifications, functions, or benefits of a good or item offered to a user.

The term “service information” refers to data describing characteristics, conditions, features, or benefits of a service provided to a user.

The term “explanation‑content data” refers to data representing explanation content generated by the generative information processing model for describing products, services, or concepts.

The term “customer‑service script” refers to textual or structured content describing recommended phrases, dialogue flows, or interaction patterns for engaging with a customer.

The term “evaluation information” refers to data representing explicit or implicit assessments by a user regarding usefulness, appropriateness, or quality of presented content or system behavior.

The term “operation‑history information” refers to data representing records of user operations, such as content selections, navigation actions, question submissions, or timing of interactions.

The term “construction rule of the prompt sentence” refers to logic or parameters determining how a prompt sentence is formed, including selection and ordering of instruction phrases and inclusion of context data.

The term “content‑generation condition” refers to one or more parameters or constraints used when generating content, such as target length, target difficulty, tone, or formatting requirements.

The term “prompt‑sentence template” refers to a pre‑defined pattern or framework of a prompt sentence that can be filled with variable portions such as content type, emotional state, or domain‑specific data.

The term “content type” refers to a category to which content belongs, such as educational content, training content, or product‑explanation content.

The term “educational content” refers to content intended for teaching or learning activities, including explanations, exercises, and summaries.

The term “training content” refers to content intended for practice or skill acquisition, often related to work procedures, operations, or simulations.

The term “product‑explanation content” refers to content that describes features, advantages, and usage of a product for prospective or current users.

The term “storage device” refers to a physical or virtual component of a computer system that stores data persistently or semi‑persistently, such as a magnetic disk, solid‑state drive, memory unit, or network storage.

In the following embodiments, a server, a terminal, and a user cooperate to implement the claimed system. Each embodiment can be implemented alone or in combination, and variations and modifications described for one embodiment can be applied to others unless technically incompatible.

### A. Hardware and software configuration

The server uses one or more information processing devices each including a central processing unit (CPU), a main memory, a non‑volatile storage device, a network interface, and optionally a graphics processing unit (GPU). The server executes an operating system such as a general‑purpose server operating system and runs application software modules that implement audio extraction, speech recognition interfacing, generative AI model interfacing, emotion recognition, virtual‑person generation, data storage, and communication with terminals.

The terminal uses a computing device such as a head‑mounted display apparatus, a portable information terminal (for example, a smartphone or tablet), or a display‑equipped work‑support device. The terminal includes at least a processor, a memory, a display unit, a camera, a microphone, and a network interface. The terminal executes an operating system suitable for mobile or wearable computing and runs a client application that communicates with the server via a communication network such as the Internet or a local wireless network.

The server uses a relational database management system to store transcripts, summary data, important‑information data, question‑and‑answer knowledge information, emotion states, prompt‑sentence templates, and content‑generation conditions. The server uses a media processing library such as a general‑purpose video and audio processing toolkit to extract audio signals from video files. The server communicates with external or internal speech recognition engines and emotion recognition engines using application programming interfaces.

The server uses a generative AI model implemented as a neural network, such as a transformer‑based language model trained on large‑scale text corpora. The server accesses this generative AI model either as an on‑premise model executed on local GPU hardware or as a network‑accessible model service exposed via an application programming interface.

### B. Data structures and module configuration

The server stores, for each piece of public audio information or video information, a content record that includes at least a content identifier, a storage location of the original media file, a storage location of an extracted audio file, a language code, a content type, a use purpose, a processing status, and references to associated transcript and generated content.

The server stores, for each transcript, a transcript record that includes a transcript identifier, a reference to the underlying content record, a character string of recognized text, and optionally time‑aligned segment metadata.

The server stores, for each generated output of the generative AI model, a content‑variant record that includes a variant identifier, a reference to the underlying transcript, a content type (such as educational content, training content, or product‑explanation content), a variant role (such as summary, key points, procedure, agenda, answer, or adapted content), an emotion condition if applicable, and the generated text.

The server stores, for each prompt‑sentence template, a template identifier, a content type, a variant role, an optional emotion condition, and a parameterized natural‑language string with slots for variables such as content type, emotion label, target difficulty, and maximum length.

The server configures a generative‑AI interface module, an emotion‑recognition module, a prompt‑construction module, a virtual‑person module, and a terminal‑communication module as separately executable components that communicate via message queues or procedure calls.

### C. Generative AI model structure and training

The server uses a generative AI model configured as a multi‑layer transformer architecture. The generative AI model includes an input embedding layer, a plurality of self‑attention layers, feed‑forward layers, and a final output projection layer over a vocabulary of tokens.

The server uses a tokenization procedure that maps character data to subword units, and the server represents prompt sentences and user content as sequences of such tokens. The server uses positional encodings or relative position representations when feeding token sequences into the transformer layers.

The generative AI model is trained using a supervised or self‑supervised learning method that minimizes a loss function such as a cross‑entropy loss between predicted tokens and ground‑truth tokens. The server or an external training system updates model weights by gradient‑based optimization, for example using an adaptive learning‑rate algorithm. During training, the system may apply data‑augmentation techniques such as document re‑ordering, masking of tokens, or paraphrased variants to increase robustness.

The server may further perform domain‑specific fine‑tuning of the generative AI model using training transcripts, operation manuals, and product descriptions. In this case, the server uses prompt‑annotated training examples in which each example consists of a prompt sentence and a desired output. The server trains the model to generate outputs that more accurately follow the structure and constraints encoded in prompt sentences.

By using a transformer‑based generative AI model with contextual attention over long sequences, the server can generate high‑quality summaries, procedures, and explanations with improved coherence and reduced error rate compared to rule‑based or n‑gram‑based systems. The attention mechanism allows the model to focus on semantically important segments of the transcript, which directly contributes to technical improvements in output precision and relevance.

### D. Speech recognition and audio extraction

The server receives public audio information or video information from data sources such as network storage or uploads from terminals. The server uses a video and audio processing toolkit to parse container formats, identify audio tracks, and decode compressed audio streams into uncompressed audio samples. The server stores audio samples in a format such as linear pulse‑code modulation at a sampling rate adapted to the speech recognition engine.

The server interfaces with a speech recognition engine that implements an acoustic model, a language model, and a decoding algorithm. The acoustic model may be a deep neural network that maps acoustic feature vectors (such as mel‑frequency cepstral coefficients or log‑mel spectrograms) to phonetic or character‑level probabilities. The language model may be implemented as an n‑gram model or as a neural language model. The decoding algorithm may be a beam‑search algorithm that combines acoustic and language model scores to select the most probable word sequence.

The server sends audio segments to the speech recognition engine and receives recognized text sequences as character data. The server stores the character data as transcripts with segmentation metadata that can later be used by the generative AI model to align steps or key points with original time ranges.

Because the server performs audio extraction and speech recognition as an automated pipeline, the server reduces manual transcription effort and systematically produces machine‑readable input suitable for subsequent processing. The segmentation and metadata allow efficient random access to relevant portions of the transcript, which reduces the amount of text that must be processed by the generative AI model and thereby reduces computational cost and latency.

### E. Prompt‑sentence construction and rule updating

The server uses the prompt‑construction module to generate prompt sentences from prompt‑sentence templates and contextual variables. The server selects a template based on the content type, the variant role, and optionally a detected emotional state. For example, for generating a factory procedure summary, the server selects a template:

“Summarize the following factory operation procedure in clear step‑by‑step bullet points suitable for display on smart glasses. Emphasize safety checks at each step.”

The server fills slots in the template with parameters such as maximum number of steps or desired output language. For a lecture summary, the server may construct a prompt sentence:

“Summarize the following lecture into a concise outline and list five key points that a beginner should remember.”

For creating an agenda, the server may construct a prompt sentence:

“Based on the following training transcript, create a 60‑minute agenda with section titles, time allocations, and short descriptions.”

For question‑and‑answer processing, the server may construct a prompt sentence:

“Answer the following question about generative AI models in simple, non‑technical terms suitable for a beginner: [question text].”

The server stores evaluation information and operation‑history information for each interaction. Evaluation information may include explicit user ratings of output usefulness or difficulty. Operation‑history information may include which variant the user chose or how often the user requested simplification or additional detail. The server applies heuristic or statistical algorithms to update template parameters and selection rules, such as reducing typical output length if many outputs are marked as “too long,” or increasing explicitness of safety instructions if many users request clarifications on safety.

By refining prompt‑sentence construction rules automatically based on data from multiple sessions, the server incrementally improves the efficiency and quality of generative AI outputs without re‑training the underlying model for each minor adjustment. This dynamic prompt control improves computer‑implemented content generation by embedding adaptive control logic into the prompt‑construction module.

### F. Emotion recognition and control of content adaptation

The terminal captures images of the user’s face through a camera and records user voice through a microphone. The terminal may pre‑process images by down‑sampling and cropping to a facial region to reduce bandwidth and then transmits the processed images and audio snippets to the server.

The server uses an emotion‑recognition module comprising a convolutional neural network for image analysis and a recurrent or transformer‑based network for voice analysis. The convolutional neural network receives facial‑expression image data and outputs a probability distribution over emotion labels such as “joy,” “confusion,” “sadness,” “interest,” and “neutral.” The recurrent or transformer‑based network receives a sequence of acoustic features extracted from voice data and outputs an emotion distribution over similar labels.

The server fuses the two distributions, for example by computing a weighted average or applying a small feed‑forward network that receives both distributions and outputs a combined emotional state estimate. The server stores the combined emotional state as time‑indexed emotion data associated with the user session.

The server passes the emotional state as an explicit control parameter to the prompt‑construction module. For example, when the emotional state indicates confusion, the server constructs a prompt sentence such as:

“The learner appears confused. Rewrite the following explanation in very simple language for a beginner, and add one easy example with step‑by‑step reasoning.”

When the emotional state indicates high engagement or joy, the server may construct:

“The learner appears joyful and highly engaged. Using the following summary, generate a more advanced version of the explanation and add one challenging example problem.”

By feeding emotion‑derived control signals into prompt sentences in a machine‑interpretable manner, the server modifies content generation behavior in ways not achievable by static scripts. The system thereby improves computer functionality by enabling the generative AI model to dynamically adapt content complexity and style based on real‑time emotion signals, reducing the need for manual reconfiguration and providing tailored outputs with minimal latency.

### G. Virtual‑person model generation and synchronization

The server receives video data of a specific person whose appearance and behavior are used as a source for a virtual‑person model. The server performs face detection and landmark detection on frames extracted from the video. The server trains a generative adversarial network or a neural rendering model that maps facial landmarks and expression parameters to corresponding pixel‑level face images. Alternatively, the server trains a parametric 3D face model that associates control parameters with facial expressions and motions.

The server attaches a motion‑representation model that encodes head movements and upper‑body gestures extracted from the input video. The server stores the trained virtual‑person model as a combination of face parameters, motion parameters, and rendering functions.

The server drives this virtual‑person model by synchronizing phoneme‑aligned content data with facial expression controls and motion patterns. For example, the server converts generated answer text or explanation content into phoneme sequences using a text‑to‑phoneme module and then maps phonemes to mouth shapes using a pre‑calibrated viseme table. The server aligns prosodic features of synthesized speech with corresponding head movements and gestures.

The terminal renders the virtual‑person model using a 3D rendering engine. The terminal receives animation parameters from the server and displays a virtual lecturer or sales assistant whose expressions and motions are synchronized to generated content. Because the virtual‑person model is directly controlled by parameters derived from the generative AI output and emotion‑dependent scripts, the avatar behavior changes in real time as content or user emotion changes, which is not possible with pre‑rendered animation.

### H. Example: Factory training and work support

The server receives a training video showing an operation procedure for a machine. The server extracts audio, performs speech recognition, and stores the transcript. The server determines that the content type is training content and the use purpose includes procedure extraction and work‑support display.

The server constructs a prompt sentence:

“Summarize the following machine operation procedure in clear step‑by‑step bullet points for display on smart glasses. Emphasize safety checks at each step.”

The server inputs the prompt sentence and transcript into the generative AI model, which produces a list of steps, each containing a short instruction and a safety note where appropriate. The server stores the generated steps as training content.

The terminal worn by a worker in the factory obtains the procedural content from the server and displays each step as an augmented‑reality overlay aligned with the worker’s field of view. The worker confirms completion of each step via a gesture or voice command. The terminal records time stamps and step progress for later analysis.

Because the server pre‑processes transcripts into compact step structures tailored for AR display, the terminal needs to transfer and render only short, structured elements. This reduces communication load and processing time on the terminal and enables low‑latency updating of instructions as the worker progresses.

### I. Example: Online lecture with adaptive difficulty

The server receives audio and video of an educational lecture. The server transcribes the audio and generates a lecture summary and key points using a prompt sentence such as:

“Summarize the following lecture into a concise outline and list five key points that a beginner should remember.”

The server also generates a simplified version and an advanced version of certain portions of the content using different prompt sentences:

“Rewrite the following explanation in very simple language for a beginner.”

“Rewrite the following explanation in a more advanced manner for an expert audience, including technical terminology.”

The terminal displays a digital lecturer based on the virtual‑person model and plays the base explanation.

The terminal captures the learner’s face and voice and sends data to the server. The server detects confusion and requests a simpler explanation by constructing an adaptation prompt sentence:

“The learner appears confused. Rewrite the following explanation in very simple language for a beginner, and add one easy example with step‑by‑step reasoning.”

The server generates adapted content and sends it to the terminal, which pauses the base lecture and inserts the adapted explanation. This loop constitutes a technical control flow in which emotion‑derived feedback drives content adaptation through prompt‑guided generative processing.

### J. Example: Virtual store and clerk support

The server stores product descriptions, specifications, and associated metadata. The server receives user selections or gaze events from a virtual‑reality terminal. The server constructs a prompt sentence for product explanation:

“Using the following product data, generate a concise, friendly explanation of this product’s main advantages for an average customer.”

The server receives an explanation from the generative AI model and passes it to the terminal, which drives a digital person avatar in the virtual store.

The terminal simultaneously sends emotion data indicating, for example, that the user is hesitant. The server constructs a further prompt sentence:

“The customer appears hesitant. Provide a short, reassuring explanation focusing on ease of use, warranty, and after‑sales support.”

The server generates an additional script and sends it to the terminal, which has the avatar deliver the adapted explanation. This process improves the technical functioning of the system by selecting only contextually relevant details, thereby reducing screen clutter and cognitive overload and enabling more efficient interactions.

In a physical store, a terminal in the form of smart glasses worn by a clerk displays recommended customer‑service scripts derived from prompt‑guided generative processing. For example, the server constructs:

“The customer is interested in this mid‑range smartphone but seems anxious about the price. Based on the following product description and promotion details, generate a short, polite script that reassures the customer and emphasizes value and the current discount.”

Because scripts are generated based on both structured product data and measured emotional state, the clerks receive technically optimized suggestions that would be difficult to compute manually in real time.

### K. Technical effects and improvement of computer technology

The server improves processing speed by applying a staged pipeline design, where audio extraction, speech recognition, generative processing, and emotion‑aware adaptation are decoupled but share structured intermediate representations. By storing transcripts, summaries, and key points in normalized database tables, the server can reuse intermediate results across multiple sessions and tasks, reducing redundant computations.

The server improves content‑generation accuracy by combining domain‑specific prompt‑sentence templates, emotion‑driven adaptation, and fine‑tuned generative AI models. This integration reduces hallucinated content and maintains consistent output formats, which in turn simplifies downstream parsing and display.

The server improves data management by defining explicit data structures for transcripts, content variants, emotion states, templates, and histories, which enables efficient indexing, retrieval, and analysis. The server avoids generic “black‑box” use of AI by encoding control logic in prompt‑sentence construction and in template update rules, which supports deterministic and testable behavior.

The server reduces communication load by generating compact, task‑specific outputs such as step‑wise procedures and short scripts that can be transmitted more efficiently than full transcripts or raw media. The server allows terminals with limited computational resources to offload heavy processing while still participating in real‑time, adaptive interactions.

The server uses machine‑learning models not merely to replicate human summarization or explanation but to implement new, non‑conventional processing strategies that combine emotion signals, structured prompts, and domain‑specific templates to control generative behavior. These strategies differ from human heuristics and from traditional rule‑based or generic chatbot systems and specifically target technical improvements in latency, computation efficiency, and content relevance.

Alternative embodiments may replace individual modules with functionally equivalent components. For example, the speech recognition engine may use different acoustic features or network architectures, the emotion‑recognition module may rely solely on facial images or solely on voice, and the virtual‑person model may be a purely 2D avatar rather than a 3D model. The generative AI model may be implemented as any neural sequence‑generation architecture capable of processing prompt sentences and producing text, including recurrent networks with attention or other transformer variants. The prompt‑construction rules may be defined using rule‑based logic, decision trees, or learned policy networks.

In all such embodiments, the server, the terminal, and the user interact as described to realize a system that transforms heterogeneous audio‑visual inputs into structured, emotion‑aware, and dynamically adaptable content under programmatic control, thereby achieving technical effects that improve the operation of computer systems beyond simple automation of human tasks.

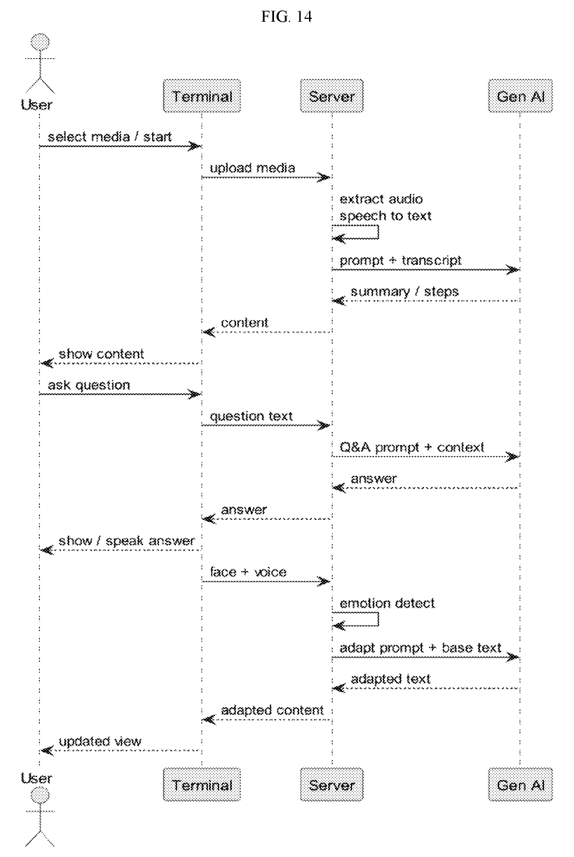

The following describes the processing flow using FIG. 14.

### Step 1

Server acquires public audio information or video information from a storage device or a network source.

Input: media file (for example, an audio file or a video file) including spoken lecture, training, or operation content.

Output: registered content record with a unique content identifier and a stored media file path.

Server parses metadata (such as file format, duration, language hint) and writes a content record into a database. Server stores the media file in a file system or object storage and associates the storage path with the content identifier.

### Step 2

Server extracts an audio signal from the acquired media file.

Input: content identifier and media file path.

Output: audio file containing decoded speech samples, and an updated content record referencing the audio file.

Server uses a media processing library to demultiplex the media file, separate the audio track from the video track if present, decode compressed audio into an uncompressed waveform (for example, linear PCM), and save the resulting audio file. Server updates the database to link the audio file to the content identifier and marks the processing status as “audio_extracted.”

### Step 3

Server converts the audio signal into character data by using a speech recognition technique.

Input: audio file corresponding to the content identifier.

Output: transcript text and a transcript record with optional segmentation metadata.

Server splits the audio into segments of suitable length, computes acoustic features (for example, spectrograms), sends segments to a speech recognition engine, and receives recognized text segments. Server concatenates the segments, optionally maintains time stamps for each segment, and stores the resulting character data as a transcript associated with the content record.

### Step 4

Server classifies a type of content and determines a use purpose.

Input: transcript text and content metadata (for example, tags such as “training,” “lecture,” “product_demo”).

Output: content type label and use‑purpose label stored in the content record.

Server analyzes keywords, structure, and length of the transcript, and evaluates predefined rules or a lightweight classifier to decide whether the data is educational content, training content, or product‑explanation content, and whether the main purpose is summarization, procedure extraction, agenda generation, or question‑and‑answer support. Server writes the determined labels into the database.

### Step 5

Server constructs a prompt sentence for a generative AI model based on the content type and the use purpose.

Input: content type label, use‑purpose label, and transcript text.

Output: a prompt sentence that instructs a generative AI model to perform a target task.

Server selects a prompt‑sentence template from a template table, fills in variable fields such as target difficulty, number of key points, or time length, and generates a complete natural‑language instruction. For example, server may produce:

“Summarize the following lecture into a concise outline and list five key points that a beginner should remember.”

Server stores the constructed prompt sentence with a reference to the transcript.

### Step 6

Server prepares a combined input for the generative AI model.

Input: prompt sentence and transcript text associated with the content identifier.

Output: tokenized input sequence suitable for the generative AI model.

Server concatenates the prompt sentence and the transcript into a single text sequence, applies a tokenizer to convert characters into tokens or subword units, and generates an input tensor representing token indices with positional encodings. Server passes the tensor to the generative AI model interface.

### Step 7

Server causes the generative AI model to generate summary data and important‑information data.

Input: tokenized prompt‑plus‑transcript sequence.

Output: generated text representing a summary, key points, procedures, or agenda information.

Server executes the generative AI model, which processes the input through multiple transformer layers, computes self‑attention across tokens, and predicts output tokens one by one under a decoding strategy (for example, greedy decoding or beam search). Server receives the generated token sequence, converts tokens back to text, and obtains a summary and optionally a list of important points.

### Step 8

Server stores generated content as structured data.

Input: generated text from the generative AI model.

Output: content‑variant records including summary data and important‑information data.

Server parses the generated text to identify sections such as bullet lists, numbered steps, or headings. Server inserts these segments into database tables as separate rows, linking them to the transcript and content identifiers. Server labels each variant with a role (for example, “summary,” “key_points,” “procedure,” “agenda”).

### Step 9

Server generates educational display content and work‑support display content based on the stored variants.

Input: summary data, important‑information data, and use‑purpose label.

Output: formatted display content optimized for terminals.

Server builds display structures, such as step‑wise sequences for procedures or slide‑like segments for lectures. Server includes meta‑information (for example, step numbers, safety flags, and text lengths) and encodes the display content into a structured format (for example, a JSON object or another internal structure) suitable for transmission to terminals.

### Step 10

Terminal requests display content from the server.

Input: request containing content identifier and desired mode (for example, “procedure_for_AR,” “lecture_summary,” “product_explanation”).

Output: display content data received from the server.

Terminal sends a network request to the server’s content API, including user identification and device capabilities. Terminal receives structured content data that matches the requested mode and stores it temporarily in local memory.

### Step 11

Terminal renders display content on a visual display apparatus.

Input: structured display content data corresponding to a specific mode.

Output: images, text, or augmented‑reality overlays visible to the user.

Terminal parses the structure into visual elements (titles, bullet points, step numbers) and uses a user interface framework or rendering engine to show them on the display or to overlay them in the user’s field of view. Terminal may implement “next” and “previous” controls so the user can navigate through content steps.

### Step 12

User consumes the displayed content and optionally interacts with it.

Input: educational display content or work‑support display content on the terminal.

Output: user actions such as navigation, confirmations, or question entries.

User reads instructions or explanations, performs tasks in the real environment if applicable, and provides input by tapping, gesturing, or speaking. User may enter questions related to the current content or request simplification or more detail.

### Step 13

Terminal captures a user question and transmits it to the server.

Input: user speech or text input representing a question.

Output: question text sent to the server.

Terminal uses a keyboard interface to obtain text or a microphone plus a local or remote speech recognizer to convert spoken questions into character data. Terminal packages the question text with context such as content identifier and current step and forwards it to the server via a network request.

### Step 14

Server processes the user question and constructs a question‑specific prompt sentence.

Input: question text, question context, and question‑and‑answer knowledge information (if available).

Output: a new prompt sentence for question answering.

Server selects a question‑answer template and fills in context, for example:

“Answer the following question about generative AI models in simple, non‑technical terms suitable for a beginner: [question text].”

Server may append relevant summary data or key points to give the generative AI model additional context.

### Step 15

Server obtains an answer text from the generative AI model.

Input: prompt sentence for question answering and associated context text.

Output: generated answer text corresponding to the user question.

Server tokenizes the combined prompt and context, feeds the tokens into the generative AI model, and receives a generated token sequence representing an answer. Server decodes tokens into text, optionally trims extraneous information, and stores the answer text as part of the question‑and‑answer log.

### Step 16

Server transmits the answer text to the terminal.

Input: answer text and destination terminal identifier.

Output: answer message delivered to the terminal.

Server wraps the answer text in a response structure that includes identifiers for the question and content. Server sends this response back to the terminal via a network response or push notification.

### Step 17

Terminal presents the answer to the user.

Input: answer text received from the server.

Output: visual or audio presentation of the answer.

Terminal displays the answer as on‑screen text or uses a text‑to‑speech engine to convert it to audio. Terminal may animate a digital or virtual person to speak the answer using synchronized lip‑movement and gestures if such a model is available on the device.

### Step 18

Terminal captures facial‑expression image data and voice data of the user during content consumption.

Input: current camera frames and current microphone signals.

Output: processed image and audio samples sent to the server.

Terminal periodically samples the camera and microphone, selects frames featuring the user’s face, extracts short audio clips, optionally applies compression or cropping, and transmits these samples along with time stamps and session identifiers to the server.

### Step 19

Server estimates an emotional state of the user based on image and voice analysis.

Input: facial‑expression image data and voice data from the terminal.

Output: emotional state label and associated probability scores.

Server applies a convolutional neural network to detect facial landmarks and infer facial expressions, and applies a sequence model to acoustic features to infer vocal affect. Server combines both results to compute an emotional state such as “joy,” “confusion,” or “hesitation” and stores this state with a time index linked to the user session.

### Step 20

Server constructs an adaptation prompt sentence for emotion‑aware content adjustment.

Input: emotional state, previously generated summary data or display content, and content type.

Output: a new prompt sentence specifying how to adjust the content.

Server selects a template that corresponds to the emotional state and content type. For example, if the emotional state is confusion, server may generate:

“The learner appears confused. Rewrite the following explanation in very simple language for a beginner, and add one easy example with step‑by‑step reasoning.”

If the emotional state is high engagement, server may generate:

“The learner appears joyful and highly engaged. Using the following summary, generate a more advanced version of the explanation and add one challenging example problem.”

### Step 21

Server generates adjusted content data using the generative AI model.

Input: adaptation prompt sentence and base content (for example, a portion of the original explanation).

Output: adjusted content text tuned to the current emotional state.

Server concatenates the adaptation prompt and the base content, tokenizes the text, executes the generative AI model to produce a new explanation or script, and decodes the result into text. Server labels the result as “simplified_content,” “advanced_content,” or another variant description and stores it as an adjusted content variant.

### Step 22

Server sends adjusted content data to the terminal for immediate update.

Input: adjusted content variant and terminal identifier.

Output: adaptation message delivered to the terminal.

Server selects the adjusted content appropriate for the current user and content step, wraps the text in a message including variant metadata, and transmits it. Server may also send indicators that instruct the terminal to replace specific sections of the currently displayed content.

### Step 23

Terminal updates displayed content or audio based on the adjusted content data.

Input: adaptation message containing adjusted content text.

Output: updated screen or audio reflecting the new difficulty level, detail level, or expression style.

Terminal identifies which local view or audio segment corresponds to the adjusted content and replaces or augments it with the new text. Terminal re‑renders text on the screen, updates speech output, or causes a virtual lecturer to deliver the new explanation, thereby closing the content adaptation loop.

### Step 24

Server analyzes video data of a specific person and generates a virtual‑person model.

Input: video data containing the specific person and facial and motion information.

Output: virtual‑person model data including facial and motion control parameters.

Server detects faces, extracts facial landmarks and motion trajectories, and trains a generative rendering model or a parametric 3D model. Server encodes control parameters for expressions and gestures, and stores the resulting virtual‑person model so that it can later be driven by content scripts.

### Step 25

Server synchronizes content data with virtual‑person control parameters.

Input: content text (for example, summary, explanation, or answer text) and virtual‑person model.

Output: animation cues linked to the content text.

Server converts the content text into phoneme sequences and timing using a text‑to‑speech or text‑to‑phoneme component, maps phonemes to visemes, and assigns corresponding face and head movement parameters. Server packages the audio or phoneme timing with control parameters and sends them to the terminal.

### Step 26

Terminal renders the virtual‑person model with synchronized speech and motion.

Input: virtual‑person model data and animation cues from the server.

Output: visual animation of a digital person speaking and gesturing in synchrony with content.

Terminal uses a rendering engine to apply face and body animations according to control parameters, plays synchronized audio, and displays the result on the display or in a virtual‑reality environment.

### Step 27

Server collects evaluation information and operation‑history information from the terminal.

Input: logs indicating user ratings, navigation behavior, and use of simplified or advanced content.

Output: updated statistics and rule parameters for prompt‑sentence construction and content generation conditions.

Server receives log entries (for example, “user requested simplification three times in this section”) and rating data (for example, “output useful = true”). Server aggregates these data over time and content types and adjusts template parameters, such as decreasing default length or adjusting target difficulty. Server updates prompt‑sentence templates and records new content‑generation conditions to improve future model calls.

### Step 28

User continues to use the system with progressively refined behavior.

Input: improved display content and interaction behavior of the system.

Output: further interactions that are processed with updated rules and conditions.

User experiences more accurate, concise, and appropriate content as the server refines internal rules. User continues asking questions, following procedures, or exploring products, while the system uses the updated prompt sentences and adaptation logic to enhance responsiveness and relevance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model bis input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

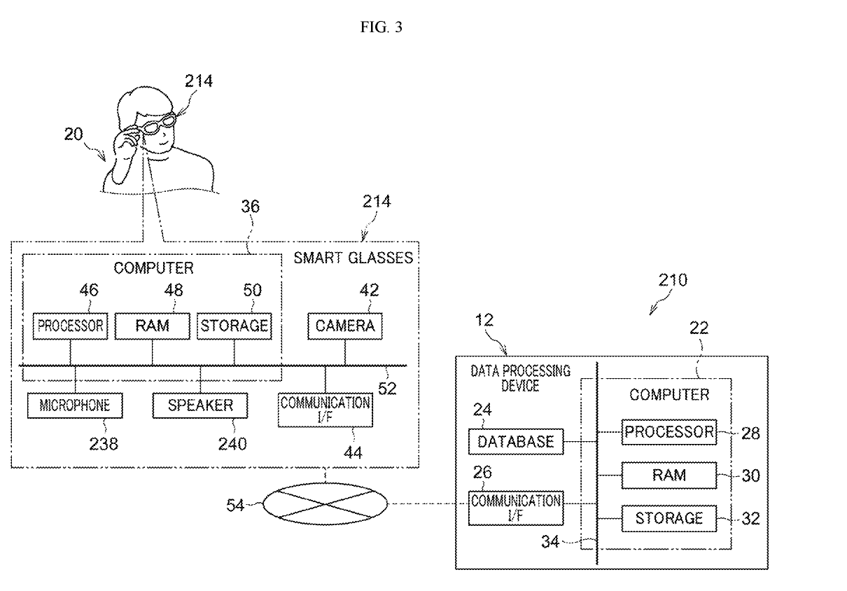

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

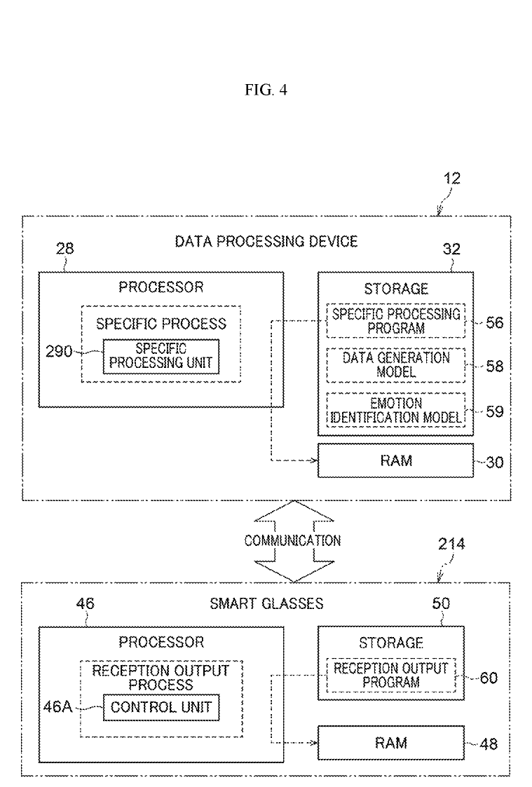

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

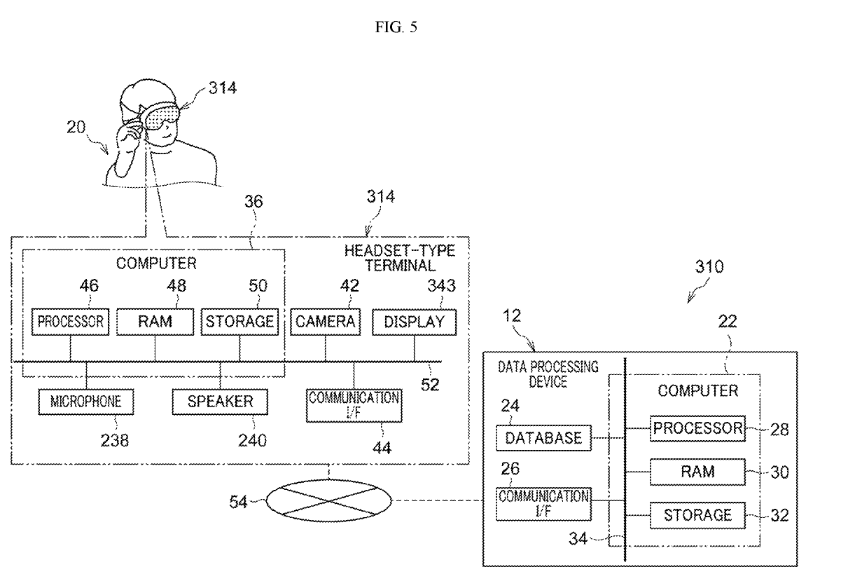

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

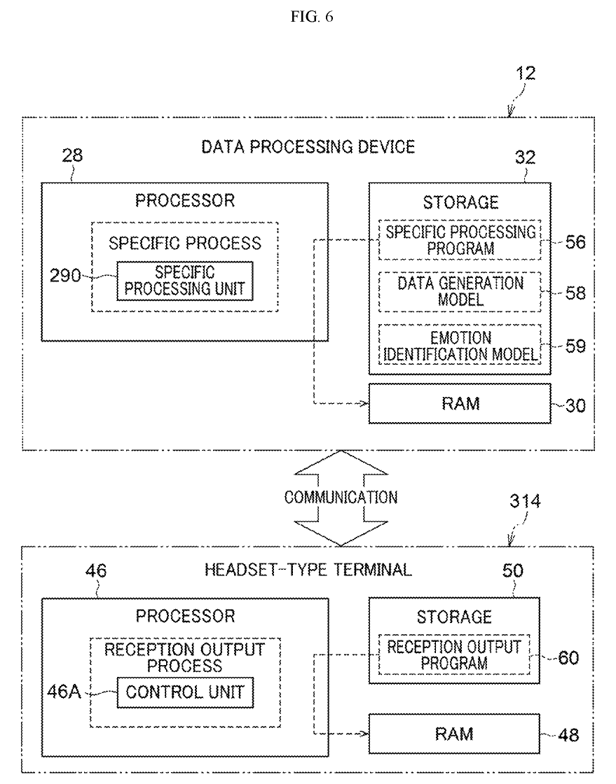

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

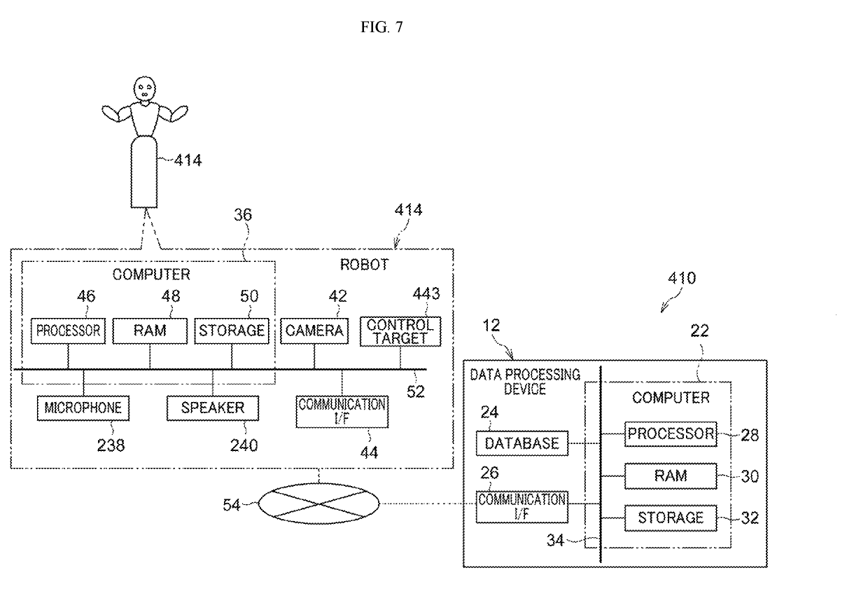

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

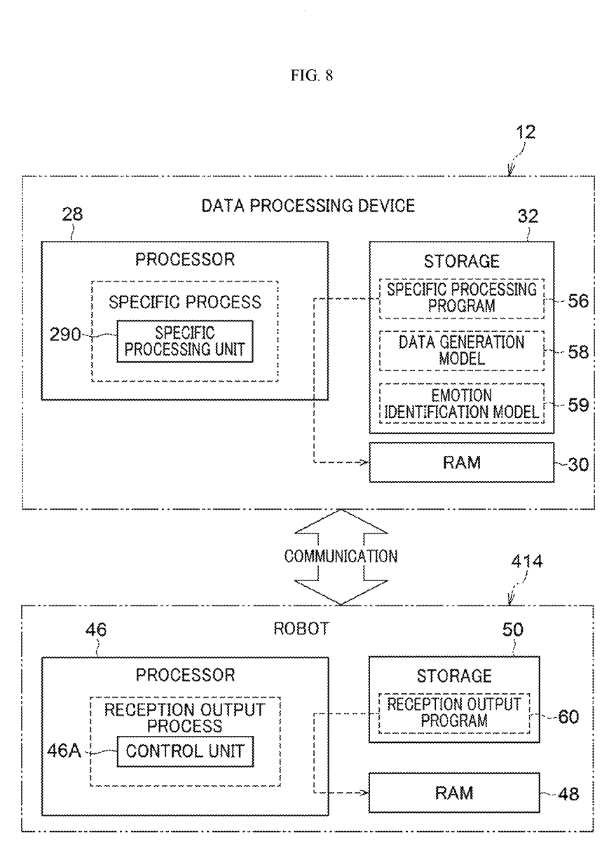

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

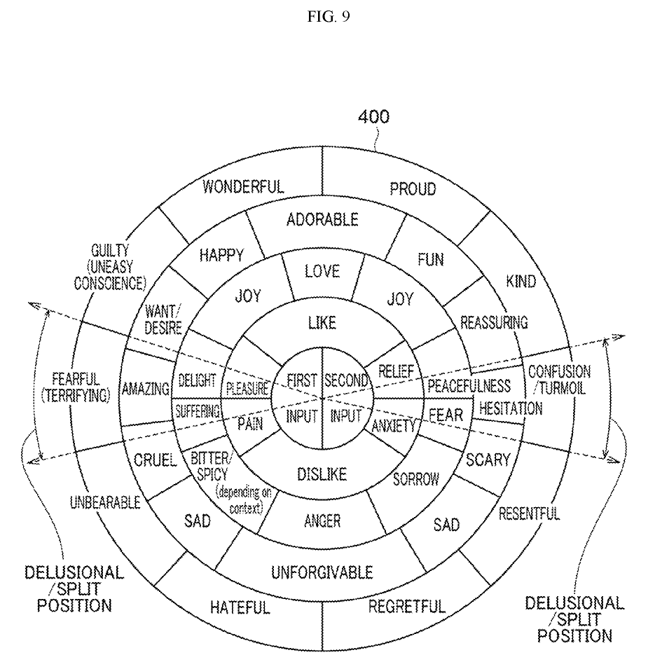

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

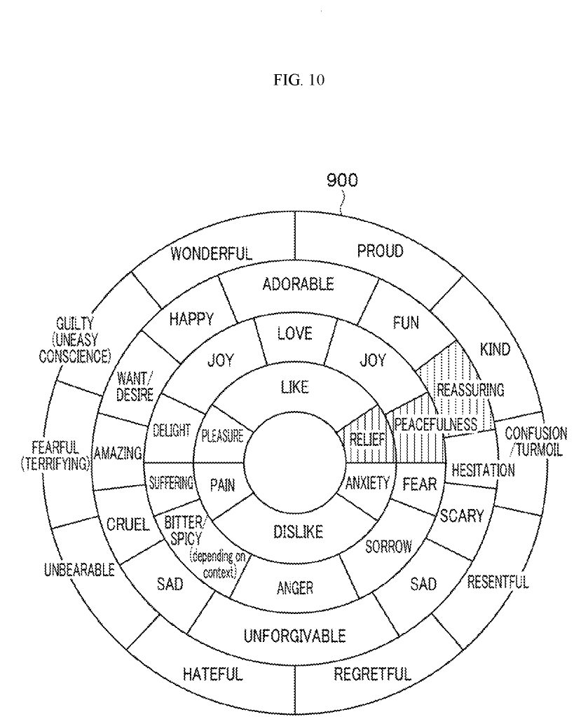

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a storage device, and a communication device,

wherein the processor is configured to receive, via the communication device, information including audio or video obtained from a public medium, and temporarily store the information in the storage device,

wherein the processor is configured to analyze the information stored in the storage device using an analysis program and a media processing program to separate an audio component, convert the audio component into character information using a speech recognition program and an external processing device having a speech recognition function, and format the character information into distribution data that is obtainable by a user,

wherein the processor is configured to generate instruction information for creating a prompt sentence that instructs at least one of summarization, important information extraction, educational material creation, and interactive response generation based on the distribution data, and to input the distribution data and the prompt sentence to a generative information processing model in accordance with the instruction information so as to obtain at least one of summary data, important information data, educational material data, and interactive response data,

wherein the processor is configured to use the interactive response data to construct a search program and a dialogue program that search knowledge information based on relevance between a question sentence and the distribution data, automatically generate a prompt sentence for the generative information processing model, automatically process questions and answers in the information, and realize a fully automated training question-and-answer function, and

wherein the processor is configured to generate motion information and speech information of a virtual person based on at least one of the summary data, the important information data, and the educational material data, input the speech information to a speech synthesis program to generate synthetic speech, and synchronize the synthetic speech with the motion information to generate display images and audio output of the virtual person.

### Supplementary 2

The system according to supplementary 1,

wherein the processor is configured to convert data stored in the storage device, including the character information, into numerical representations using a feature transformation program, construct a search data set based on the numerical representations, convert a question sentence from a user into a numerical representation using the feature transformation program, calculate similarity between the numerical representation of the question sentence and the search data set, extract related information based on the similarity, generate a prompt sentence including the question sentence and the related information, and input the prompt sentence to the generative information processing model so as to cause the generative information processing model to generate a response sentence.

### Supplementary 3

The system according to supplementary 1,

wherein the processor is configured to generate processing state information according to at least one of a creation state of the distribution data and a creation state of a prompt sentence for the generative information processing model, transmit the processing state information to a terminal device via the communication device, and cause the terminal device to display at least one of the processing state information, the distribution data, and output data obtained from the generative information processing model.

### Application Example 1

### Supplementary 1

A system comprising a processor,

wherein the processor is configured to

acquire published video information or audio information, and convert an audio signal included in the video information or the audio information into character information by using an acoustic analysis unit based on speech recognition technology, and

divide the character information based on time information, generate input information including a prompt sentence for a generative AI model so as to cause the generative AI model to generate at least one of summary information, important information, agenda information, or translation information from the divided character information, and input the input information to the generative AI model, and

store the summary information, the important information, the agenda information, or the translation information output from the generative AI model, and generate at least one of educational material information or learning progress information based on the stored information, and

acquire question‑and‑answer information associated with the video information or the audio information, generate a prompt sentence for causing the generative AI model to perform dialogue processing based on a correspondence between the question‑and‑answer information and the character information, and realize an automated training process based on response information output from the generative AI model, and

construct subtitle information from at least one of the character information or the summary information output from the generative AI model, and generate display control information for performing time‑series subtitle display on a display device based on a correspondence between character information included in the subtitle information and the video information or the audio information, and

generate at least one of utterance information, expression information, or motion information of a virtual person based on at least one of the character information, the summary information, or the educational material information output from the generative AI model, and generate educational presentation information using the virtual person.

### Supplementary 2

The system according to supplementary 1,

wherein the processor is configured to, when the video information or the audio information includes audio signals in a plurality of languages, execute language determination processing on the character information obtained by the acoustic analysis unit, switch the prompt sentence supplied to the generative AI model based on a result of the language determination processing, and generate translation information and subtitle information according to user setting information.

### Supplementary 3

The system according to supplementary 1,

wherein the processor is configured to, based on operation information acquired from a user terminal, selectively present at least one of the subtitle information, the summary information, the agenda information, or the response information on the display device, and use character information or summary information corresponding to a time position designated by the operation information as additional input to the generative AI model so as to cause the generative AI model to generate additional explanation information or supplementary response information related to the designated time position.

### Example 2

### Supplementary 1

A system comprising a processor,

wherein the processor is configured to

extract audio information from video information including publicly available information, and convert the audio information into character information by using a speech recognition technology,

store the character information in association with identification information, acquire the character information on the basis of the identification information, generate input information including the character information and a prompt sentence, and input the input information to a generative AI model so as to cause the generative AI model to generate summary information and important information,

convert the summary information and the important information into a predetermined document format or plan format, structure the converted information as distribution materials or schedule tables, and generate electronic documents including the structured information,

generate character setting information and dialogue information of a virtual person on the basis of the character information and the summary information, input a prompt sentence for responding to the dialogue information to the generative AI model so as to cause the generative AI model to generate question-and-answer information, and execute automatic response processing by an interactive program by using the question-and-answer information, and

generate visual information and audio information of the virtual person on the basis of the character setting information and the question-and-answer information, synchronize motion information and expression information as the visual information with voice synthesis information as the audio information, and provide fully automated training in which an instructor is virtualized.

### Supplementary 2

The system according to supplementary 1,

wherein the processor is configured to

associate the character information and the prompt sentence with a plurality of kinds of output format designation information, cause the generative AI model to generate at least one of the summary information, the important information, question information, and learning plan information in accordance with the output format designation information, and perform output control by selecting different electronic document formats or interactive formats for each piece of the generated information.

### Supplementary 3

The system according to supplementary 1,

wherein the processor is configured to

store the character setting information, the dialogue information, and the question-and-answer information in association with an input history to the generative AI model, and automatically generate or supplement a subsequent prompt sentence to the generative AI model on the basis of the input history so as to sequentially update dialogue content and behavior of the virtual person adapted to training content and response history of a trainee.

### Application Example 2

### Supplementary 1

A system comprising a processor,

wherein the processor is configured to

acquire public audio information or video information, extract an audio signal from the audio information or the video information, and convert the audio signal into character data by using a speech recognition technique,

construct, in accordance with a type of content and a use purpose of the character data, a prompt sentence for causing a generative information processing model to generate at least one of summary information, important information, procedure information, and meeting‑progress information, input the prompt sentence and the character data to the generative information processing model, and cause the generative information processing model to execute natural language processing to generate summary data and important‑information data,

generate, on the basis of the summary data and the important‑information data generated by the generative information processing model, at least one of educational display content, work‑support display content, agenda information, procedure information, and question‑and‑answer knowledge information, and transmit the display content to a terminal so that the display content is sequentially displayed on a visual display apparatus of the terminal,

receive a question inputted by a user or question text transmitted from the terminal, construct a prompt sentence on the basis of the question text and the question‑and‑answer knowledge information, input the prompt sentence to the generative information processing model, cause the generative information processing model to generate answer text, and provide the answer text to the terminal via an interactive information processing program or a question‑answer information processing program so as to automate a question‑and‑answer process,

acquire facial‑expression image data and voice data of the user transmitted from the terminal, and estimate an emotional state of the user by using an image analysis technique and a voice analysis technique,

construct, on the basis of the emotional state and at least one of the summary data and the display content, a prompt sentence for adjusting at least one of a difficulty level, a detail level, and an expression style of lecture content, explanation content, and work procedure content, input the prompt sentence to the generative information processing model, cause the generative information processing model to generate adjusted content data corresponding to the emotional state, and transmit the adjusted content data to the terminal so that the adjusted content data is output as a display or audio from the terminal,

analyze video data indicating a specific person, learn facial features and motion features, generate a virtual‑person model whose facial expression and motion are controllable in synchronization with the content data generated by the generative information processing model, and cause the virtual‑person model to be displayed on a display screen or a virtual‑space display apparatus of the terminal,

present product information or service information in a virtual space or a real space via the virtual‑person model or a digital person, dynamically adjust explanation content and a customer‑service script on the basis of the emotional state and explanation‑content data generated by the generative information processing model, and output the explanation content and the customer‑service script to the terminal, and

acquire evaluation information or operation‑history information from the user, update a construction rule of the prompt sentence and a content‑generation condition on the basis of the evaluation information and the operation‑history information, and automatically adjust the prompt sentence to be used for subsequent input to the generative information processing model.

### Supplementary 2

The system according to supplementary 1,

wherein the processor is configured to control a terminal including at least one of a head‑mounted display apparatus, a portable information terminal, and a display‑equipped work‑support apparatus, and to cause the head‑mounted display apparatus or the display‑equipped work‑support apparatus to sequentially superimpose and display, as augmented‑reality display, procedure information and explanation content generated by the processor, and to cause, in response to an operation input by the user, a transition to a next procedure or a next explanation.

### Supplementary 3

The system according to supplementary 1,

wherein the processor is configured to store, in a storage device, the summary data, the important‑information data, the answer text for the question‑and‑answer process, and the adjusted content data corresponding to the emotional state, generated by the generative information processing model, while distinguishing the data as at least educational content, training content, and product‑explanation content, to hold prompt‑sentence templates corresponding to respective content types, and to select or update the prompt‑sentence templates in accordance with the content type and the emotional state, thereby dynamically switching the prompt sentence to be used for input to the generative information processing model.

What is claimed is:

1. A system comprising:
circuitry configured to:
receive, via a communication interface coupled to a packet-switched network, information including audio or video data obtained from a public medium, and store the information in a storage device;
analyze the information stored in the storage device using an analysis program and a media processing program to separate an audio component, convert the audio component into character information using a speech recognition program, and format the character information as distribution data;
generate instruction information for creating a prompt sentence that instructs at least one of summarization, important information extraction, training material creation, and interactive response generation based on the distribution data, and input the distribution data and the prompt sentence to a generative neural network model to obtain at least one of summary data, important information data, training material data, and interactive response data;
convert the distribution data into numerical representations using a feature transformation program, construct a search dataset based on the numerical representations, receive a question sentence via the communication interface, convert the question sentence into a numerical representation using the feature transformation program, compute similarity between the numerical representation of the question sentence and the search dataset, extract related information based on the similarity, and generate a prompt sentence including the question sentence and the related information for input to the generative neural network model; and
transmit a response sentence generated by the generative neural network model to a terminal device via the communication interface.

2. The system according to claim 1, wherein the circuitry is configured to perform the audio component separation by applying a media processing algorithm to identify and extract audio tracks from the received information, and to convert the audio component using a speech recognition program that includes acoustic modeling and language modeling to generate character information with timestamp alignment.

3. The system according to claim 2, wherein the circuitry is configured to format the character information into distribution data by segmenting the character information into units corresponding to time intervals, associating each segment with speaker identification information where available, and storing the segmented distribution data in the storage device with indexing metadata.

4. The system according to claim 1, wherein the circuitry is configured to generate the prompt sentence for summarization by constructing a structured instruction specifying summary length, output format, and key concept extraction criteria, and input the prompt sentence with the distribution data to cause the generative neural network model to generate summary data and important information data.

5. The system according to claim 4, wherein the circuitry is configured to generate training material data by constructing a prompt sentence that instructs the generative neural network model to organize the distribution data into a structured training format including an agenda, learning objectives, key points, and exercise items.

6. The system according to claim 1, wherein the circuitry is configured to convert the distribution data into numerical representations by applying a pre-trained encoder network to the character information segments to compute dense vector embeddings, and constructing the search dataset as an indexed collection of the embeddings linked to corresponding text segments.

7. The system according to claim 6, wherein the circuitry is configured to compute the similarity by calculating cosine similarity or inner product between the numerical representation of the question sentence and each vector in the search dataset, ranking the results, and extracting the top-ranked text segments as related information.

8. The system according to claim 7, wherein the circuitry is configured to construct the prompt sentence for question answering by organizing the question sentence, the related information, and an instruction for generating an accurate response into sections formatted for the generative neural network model.

9. The system according to claim 1, wherein the circuitry is configured to generate motion information and speech information of a virtual person based on at least one of the summary data, the important information data, and the training material data, input the speech information to a speech synthesis program to generate synthetic speech, and synchronize the synthetic speech with the motion information to generate display images and audio output for transmission to the terminal device.

10. The system according to claim 9, wherein the circuitry is configured to select motion patterns for the virtual person from a motion database stored in the storage device based on content type and emotional tone inferred from the training material data, and to apply the selected motion patterns to animate the virtual person.

11. The system according to claim 1, wherein the circuitry is configured to generate processing state information according to a creation state of the distribution data or a creation state of the prompt sentence, transmit the processing state information to the terminal device via the communication interface, and cause the terminal device to display the processing state information alongside the distribution data and output data.

12. The system according to claim 1, wherein the circuitry is configured to construct a dialogue program that uses the interactive response data and the search dataset to process successive question sentences from the terminal device, maintaining a dialogue history in the storage device, and incorporating the dialogue history as context in subsequently generated prompt sentences.

13. The system according to claim 12, wherein the circuitry is configured to detect a topic shift between successive question sentences by comparing the numerical representations of the question sentences using the similarity metric, and to update the related information extraction accordingly to maintain relevance of the context.

14. The system according to claim 1, wherein the circuitry is configured to receive, from the terminal device via the communication interface, a user evaluation of the response sentence, store the evaluation in the storage device in association with the prompt sentence and the response sentence, and use accumulated evaluations to refine the feature transformation program or the similarity threshold for subsequent retrievals.

15. The system according to claim 14, wherein the circuitry is configured to monitor a coverage metric indicating the proportion of key concepts from the important information data that have been addressed in response sentences, and transmit a proactive suggestion to the terminal device when the coverage metric falls below a threshold.

16. The system according to claim 1, wherein the circuitry is configured to support multilingual processing by detecting the language of the received audio component, applying a language-specific speech recognition model, and translating the character information into a canonical processing language before generating the prompt sentence.

17. The system according to claim 16, wherein the circuitry is configured to translate response sentences from the canonical processing language to the language of the terminal device before transmitting the response sentences via the communication interface.

18. A system comprising:
circuitry configured to:
receive, via a communication interface coupled to a packet-switched network, information including audio or video data, store the information in a storage device, and separate an audio component using a media processing program;
convert the audio component into character information using a speech recognition program, and format the character information as distribution data stored in the storage device;
generate a prompt sentence for at least one of summarization, important information extraction, and training material generation, input the distribution data and the prompt sentence to a generative neural network model, and obtain summary data, important information data, or training material data;
convert the distribution data into dense vector embeddings using a pre-trained encoder, construct a vector search dataset, receive a question sentence from a terminal device via the communication interface, compute similarity between a vector embedding of the question sentence and the search dataset, extract related information, and generate a question-answering prompt sentence including the question sentence and the related information;
input the question-answering prompt sentence to the generative neural network model and obtain a response sentence; and
transmit the response sentence to the terminal device via the communication interface.

19. The system according to claim 18, wherein the circuitry is configured to generate motion information and speech information of a virtual person based on at least one of the summary data, the important information data, or the training material data, synthesize speech from the speech information, and synchronize the synthesized speech with the motion information for display.

20. A method comprising:
receiving, via a communication interface coupled to a packet-switched network, information including audio or video data obtained from a public medium, and storing the information in a storage device;
analyzing the information stored in the storage device to separate an audio component, converting the audio component into character information using a speech recognition program, and formatting the character information as distribution data;
generating a prompt sentence that instructs at least one of summarization, important information extraction, training material creation, and interactive response generation based on the distribution data, and inputting the distribution data and the prompt sentence to a generative neural network model to obtain at least one of summary data, important information data, training material data, and interactive response data;
converting the distribution data into numerical representations using a feature transformation program, constructing a search dataset, receiving a question sentence via the communication interface, computing similarity between a numerical representation of the question sentence and the search dataset, extracting related information, and generating a prompt sentence including the question sentence and the related information; and
transmitting a response sentence generated by the generative neural network model to a terminal device via the communication interface.
